(19) United States
(12) Patent Application Publication
(10) Pub. No.: US 2025/0373980 A1
(43) Pub. Date: Dec. 4, 2025

(54) AUDIO PROCESSING METHOD AND RELATED DEVICE

(71) Applicant: Tencent Technology (Shenzhen) Company Limited, Shenzhen (CN)

(72) Inventor: Junbin LIANG, Shenzhen (CN)

(21) Appl. No.: 19/305,637

(22) Filed: Aug. 20, 2025

Related U.S. Application Data
(63) Continuation of application No. PCT/CN2024/100587, filed on Jun. 21, 2024.

(30) Foreign Application Priority Data
Aug. 9, 2023 (CN) 202310993563.4

(51) Int. Cl. H04R 3/00

(52) U.S. Cl. CPC H04R 3/00; H04R 2420/01; H04R 2430/01; H04R 2430/03; H04R 2499/15

(57) ABSTRACT

This application provides an audio processing method performed by a computer device. The method includes: obtaining a real audio signal from a real environment and a virtual audio signal from a virtual environment in an augmented reality scene; selecting one sound mixing mode from a plurality of sound mixing modes configured for the augmented reality scene as a target sound mixing mode; performing sound mixing processing on the real audio signal and the virtual audio signal according to the target sound mixing mode to obtain a sound-mixed signal; and outputting the sound-mixed signal via a speaker of the computer device. In this way, integration of sounds in an augmented reality scene is realized in an auditory dimension, thereby enriching an integration capability in the augmented reality scene, and improving an overall immersed sense of a user in the augmented reality scene.

### CROSS-REFERENCE TO RELATED APPLICATIONS

This application is a continuation application of PCT Patent Application No. PCT/CN2024/100587, entitled “AUDIO PROCESSING METHOD AND RELATED DEVICE” filed on Jun. 21, 2024, which claims priority to Chinese Patent Application No. 2023109935634, entitled “AUDIO PROCESSING METHOD AND RELATED DEVICE” filed with the China National Intellectual Property Administration on Aug. 9, 2023, both of which are incorporated herein by reference in their entirety.

### FIELD OF THE TECHNOLOGY

This application relates to the field of Internet technologies, specifically, to the field of computer technologies, and in particular, to an audio processing method and a related device.

### BACKGROUND OF THE DISCLOSURE

With the development of the augmented reality (AR) technology, functions of an augmented reality device (for example, AR glasses or an AR headset) become increasingly enriched and diversified. With the help of a capability that is provided by the augmented reality device (for example, AR glasses or an AR headset) for visually fusing images from a real world and images from a virtual world, people can immerse themselves in an augmented reality scene created by combining the real world and the virtual world, bringing some new experiences. For example, after wearing AR glasses, a user can see a synthetic image of a real world image and a virtual world image, and can change content of the virtual world image through some interaction manners such as gestures and voice. Two-dimensional images in a user environment can be further detected and enhanced by using an augmented reality application. For example, product posters can be enhanced at an exhibition. However, the foregoing only realizes image integration in the augmented reality scene in a visual dimension, the integration capability is undiversified, and an immersed sense of the user in the augmented reality scene still needs to be improved.

### SUMMARY

Embodiments of this application provide an audio processing method and a related device, so that integration of a real world sound and a virtual world sound in an augmented reality scene can be realized in an auditory dimension, thereby enriching an integration capability in the augmented reality scene, and improving an overall immersed sense of a user in the augmented reality scene.

According to an aspect, an embodiment of this application provides an audio processing method performed by a computer device, including:
obtaining a real audio signal from a real environment and a virtual audio signal from a virtual environment in an augmented reality scene;
selecting one sound mixing mode from a plurality of sound mixing modes configured for the augmented reality scene as a target sound mixing mode; and
performing sound mixing processing on the real audio signal and the virtual audio signal according to the target sound mixing mode to obtain a sound-mixed signal; and outputting the sound-mixed signal via a speaker of the computer device.

According to an aspect, an embodiment of this application provides a computer device, including:
a processor, configured to execute a computer program; and
a computer-readable storage medium, having a computer program stored therein, wherein the computer program, when executed by the processor, causes the computer device to perform the foregoing audio processing method.

According to an aspect, an embodiment of this application provides a non-transitory computer-readable storage medium, having a computer program stored therein, wherein the computer program, when executed by a processor of a computer device, causes the computer device to perform the foregoing audio processing method.

In the embodiments of this application, a real audio signal and a virtual audio signal in an augmented reality scene may be obtained, where the real audio signal is an audio signal acquired in a real environment on which the augmented reality scene is based, and the virtual audio signal is an audio signal constructed in a virtual environment on which the augmented reality scene is based. A plurality of sound mixing modes configured for the augmented reality scene are determined, and one sound mixing mode is selected from the plurality of sound mixing modes as a target sound mixing mode, where different sound mixing modes may be configured for realizing different sound mixing effects between the real audio signal and the virtual audio signal, thereby bringing different auditory experiences. By determining the plurality of sound mixing modes for the augmented reality scene, diversified selections can be provided for setting of the target sound mixing mode, and the target sound mixing mode can be flexibly set, so that various scenes in which the real audio signal and the virtual audio signal need to be mixed can be adapted to, and some personalized sound mixing requirements of the user can also be met. Sound mixing processing is performed on the real audio signal and the virtual audio signal according to the target sound mixing mode to obtain a sound-mixed signal, and the sound-mixed signal is outputted. Since the target sound mixing mode can realize a corresponding sound mixing effect between the real audio signal and the virtual audio signal, by controlling sound mixing processing on the real audio signal and the virtual audio signal in the target sound mixing mode, integration of sounds in the real world and sounds in the virtual world on which the augmented reality scene is based may be realized in an auditory dimension, so that sound integration in the augmented reality scene is increased in the auditory aspect, an integration capability in the augmented reality scene is enriched, and the obtained sound-mixed signal also has the sound mixing effect corresponding to the target sound mixing mode. The sound-mixed signal is finally outputted, so that the user can feel a sound integration effect in the augmented reality scene more intuitively, thereby improving an immersed sense of the user in the augmented reality scene.

### BRIEF DESCRIPTION OF THE DISCLOSURE

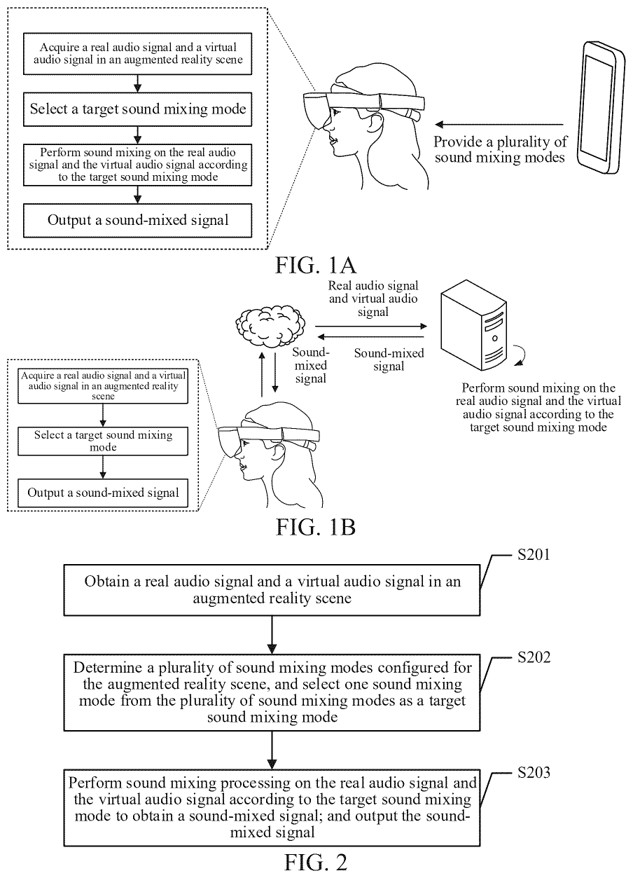

FIG. 1A is an architectural diagram of an audio processing system according to an embodiment of this application.

FIG. 1B is an architectural diagram of another audio processing system according to an embodiment of this application.

FIG. 2 is a schematic flowchart of an audio processing method according to an embodiment of this application.

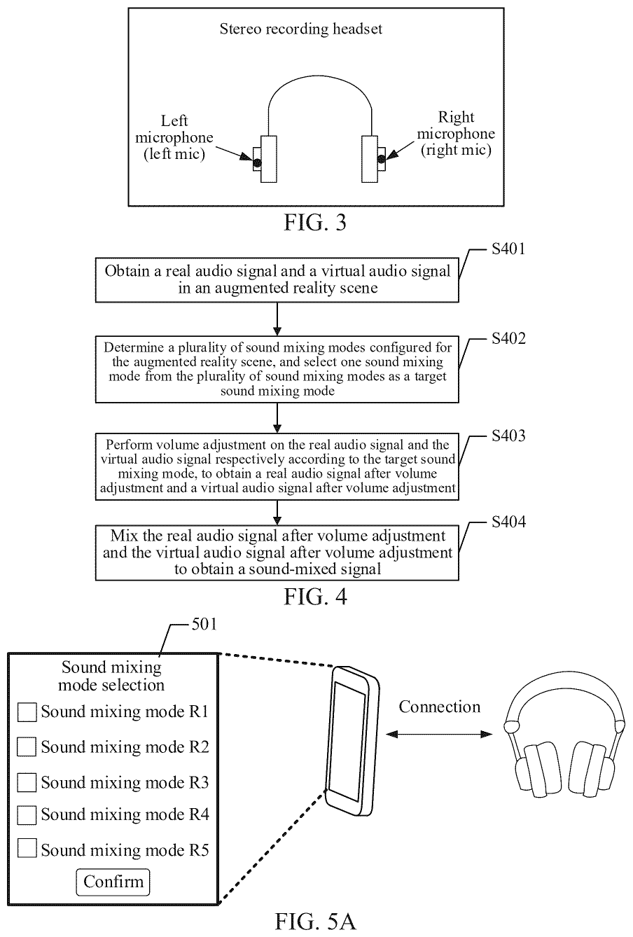

FIG. 3 is a schematic diagram of an audio acquisition device according to an embodiment of this application.

FIG. 4 is a schematic flowchart of another audio processing method according to an embodiment of this application.

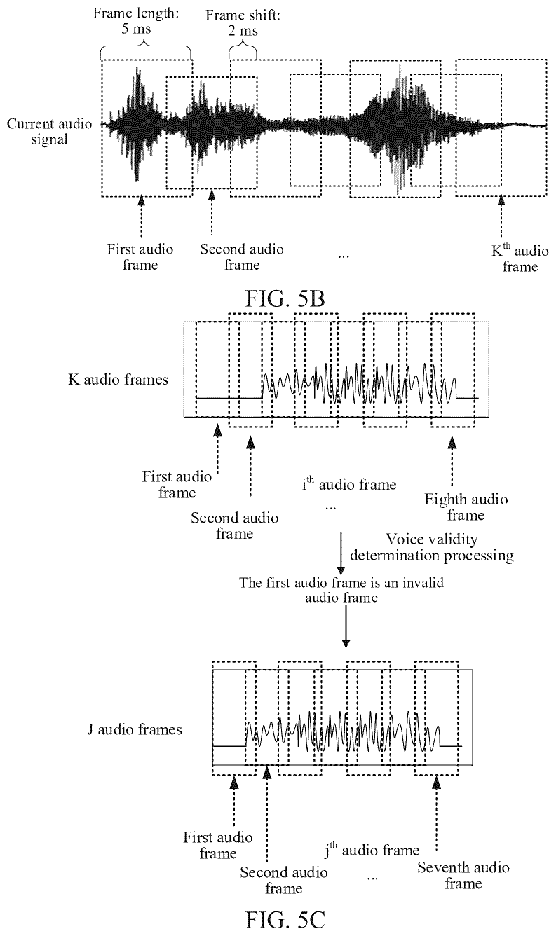

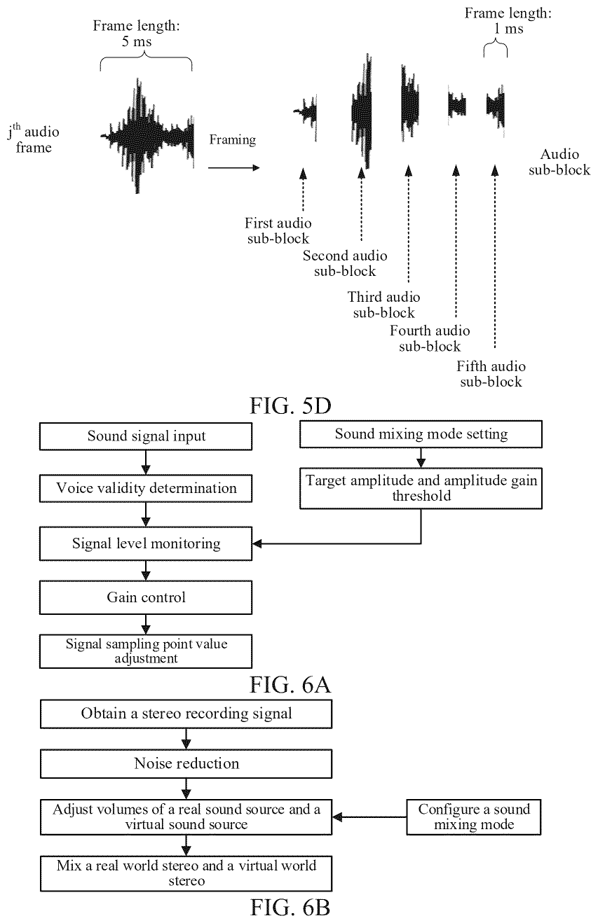

FIG. 5A is a schematic diagram of a scenario of setting a target sound mixing mode according to an embodiment of this application.

FIG. 5B is a schematic diagram of performing framing on a current audio signal according to an embodiment of this application.

FIG. 5C is a schematic diagram of a relationship between audio frames before and after voice validity determination processing according to an embodiment of this application.

FIG. 5D is a schematic diagram of dividing an audio frame into audio sub-blocks according to an embodiment of this application.

FIG. 6A is a schematic flowchart of volume adjustment according to an embodiment of this application.

FIG. 6B is a schematic diagram of an audio processing procedure according to an embodiment of this application.

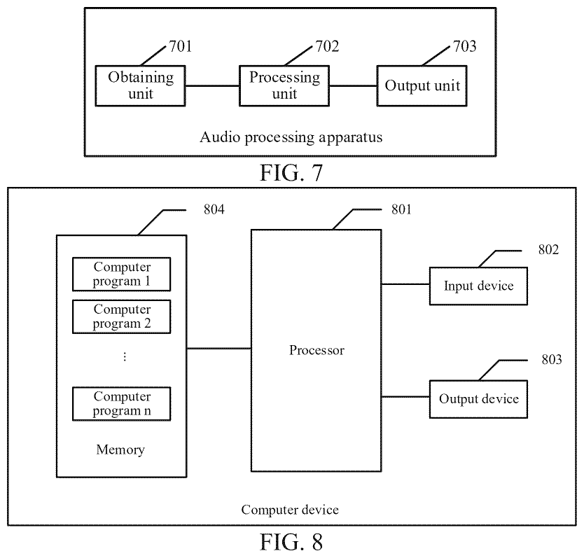

FIG. 7 is a schematic structural diagram of an audio processing apparatus according to an embodiment of this application.

FIG. 8 is a schematic structural diagram of a computer device according to embodiments of this application.

### DESCRIPTION OF EMBODIMENTS

The technical solutions in the embodiments of this application are clearly and completely described in the following with reference to the accompanying drawings in the embodiments of this application. Apparently, the described embodiments are some rather than all of the embodiments of this application. Based on the embodiments of this application, all other embodiments obtained by a person of ordinary skill in the art without creative efforts shall fall within the protection scope of this application.

This application provides an audio processing method. In the audio processing method, a target sound mixing mode may be selected from a plurality of sound mixing modes configured for an augmented reality scene, and sound mixing processing may be performed on a real audio signal and a virtual audio signal in the augmented reality scene according to the target sound mixing mode to obtain a sound-mixed signal, so that deep integration of a real world sound and a virtual world sound in the augmented reality (AR) scene in an auditory aspect can be realized, thereby enriching an integration capability in the augmented reality scene. In addition, the sound-mixed signal may be outputted, where the sound-mixed signal has a sound mixing effect corresponding to the target sound mixing mode, so that sound integration in the auditory aspect is increased based on image integration in a visual aspect, and an overall atmosphere and an immersed sense of the augmented reality scene can be improved. Through a multi-dimensional integration capability, a sense of reality of the augmented reality scene is further enhanced.

In the embodiments of this application, the augmented reality scene is an interaction scene implemented with the help of an augmented reality technology. According to interaction content, the augmented reality scene includes, but not limited to, a social scene, a game scene, a chorus scene, a live streaming scene, and the like. The augmented reality technology is a technology that skillfully integrates virtual information with the real world. It simulates computer-generated virtual information such as text, images, three-dimensional models, music, and videos by extensively using a variety of technical means such as multimedia, three-dimensional modeling, real-time monitoring and registration, intelligent interaction, and sensing, and then applies the virtual information to the real world. Two types of information complement each other to “augment” the real world. In the augmented reality scene, a user wears an AR device such as AR glasses or an AR headset, and the user can see the real world through the AR glasses and can also see a virtual image or animation that is processed through AR and projected onto lenses of the AR glasses. In addition, the user can also really hear sounds from the real world and sounds of a virtual scene from the headset, and this audio and video experience integrating reality and virtuality can bring different imagination space and experiences for the user.

The augmented reality scene is created based on a real environment and a virtual environment. The real environment is a real physical environment in which the user is located, including surrounding sceneries, objects, and sounds that can be seen, heard, and felt by the user, and is a basis of perception and interaction of people. The virtual environment is a simulated environment generated through a device. Through a corresponding technology, the user may be immersed in the virtual environment, or the virtual environment may be used to enhance the real environment, and the user may perform perception and interaction with the help of an augmented reality device (for example, AR glasses). The real environment may be understood as a portion of the real world, and the real world further includes some invisible materials other than the content that can be seen, heard, and felt by the user. The virtual environment may be understood as a portion of the virtual world, and in the virtual world, various content that can be seen, heard, and felt is completely constructed by a device. For example, the sounds in the virtual world are completely generated by a computer device. In an implementation, in the augmented reality scene, a sound signal generated by a sound source in the real environment may be acquired to form a real audio signal, and a sound signal generated by a sound source in the virtual environment may be acquired to form a virtual audio signal, where the sound signal generated by the sound source in the virtual environment is automatically constructed by a device and may be a sound signal simulating a real environment. In a specific formation process, analog-to-digital conversion may be performed on the sound signal (an analog signal) to obtain a corresponding audio signal (a digital signal).

A sound mixing mode is a mode controlling the real audio signal and the virtual audio signal to perform sound mixing, and different sound mixing modes may be configured for realizing different sound mixing effects between the real audio signal and the virtual audio signal, thereby bringing different auditory experiences. For the real audio signal and the virtual audio signal in the augmented reality scene, a target sound mixing mode may be set to control a sound mixing manner between the two signals, and mixing of sounds generated by a sound source in the virtual world and sounds generated by a sound source in the real world can be further realized, thereby enhancing a real world sound.

Based on the foregoing definitions, the following describes a principle of an audio processing method provided in the embodiments of this application. Specifically, a general principle of the method is as follows: obtaining a real audio signal and a virtual audio signal in an augmented reality scene, determining a plurality of sound mixing modes configured for the augmented reality scene, and selecting one sound mixing mode from the plurality of sound mixing modes as a target sound mixing mode. The target sound mixing mode may be selected by a user of an augmented reality device according to a use requirement of the user. For example, the target sound mixing mode may be determined according to a manual operation of the user; or the target sound mixing mode may be automatically determined by the device. By providing the plurality of sound mixing modes, sound mixing effect selections for the real audio signal and the virtual audio signal become more diversified. Sound mixing processing is performed on the real audio signal and the virtual audio signal according to the target sound mixing mode to obtain a sound-mixed signal, and the sound-mixed signal is outputted.

In a specific implementation, the foregoing mentioned method may be performed by a computer device, and the computer device may be a terminal or a server. For example, the terminal may acquire the real audio signal and the virtual audio signal in the augmented reality scene, select one sound mixing mode from the plurality of sound mixing modes based on a user instruction, perform sound mixing on the real audio signal and the virtual audio signal according to the selected sound mixing mode, and output the sound-mixed signal obtained through sound mixing, as shown in FIG. 1A. Alternatively, the foregoing mentioned method may be jointly performed by a terminal and a server. For example, the terminal acquires the real audio signal and the virtual audio signal in the augmented reality scene in real time, sends the acquired audio signals to the server, and the terminal may further receive a user operation to determine the target sound mixing mode; and the server performs sound mixing processing on the real audio signal and the virtual audio signal according to the determined target sound mixing mode to obtain the sound-mixed signal and sends the sound-mixed signal to the terminal for output, as shown in FIG. 1B.

The foregoing mentioned terminal includes, but not limited to, devices such as a smartphone, a tablet computer, a smart wearable device, a smart speech interaction device, a smart home appliance, a personal computer, an in-vehicle terminal, a smart camera, an augmented reality device (for example, AR glasses and an AR headset), and the like. This is not limited in this application. A quantity of terminals is not limited in this application. The server may be an independent physical server, or may be a server cluster including a plurality of physical servers or a distributed system, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto. A quantity of servers is not limited in this application.

The audio processing method provided in this application relate to technologies such as an artificial intelligence (AI) speech technology. Key technologies of the speech technology include an automatic speech recognition (ASR) technology, a text-to-speech (TTS) technology, and a voiceprint recognition (VPR) technology. To make a computer capable of listening, seeing, speaking, and feeling is a future development direction of human-computer interaction, and speech has become one of the most promising human-computer interaction methods in the future. A large language model (LLM) technology brings changes to the development of the speech technology, and pre-trained models such as WvaLM or UniSpeech that uses the Transformer (an attention mechanism-based neural network) architecture have strong generalization and versatility and can excellently complete voice processing tasks in various directions. In this application, when sound mixing processing is performed on the real audio signal and the virtual audio signal in the augmented reality scene, some AI models may be used to implement the processing, and the AI models include, but not limited to, a neural network, a pre-trained model, and the like.

In addition, in this application, during example application of relevant data (for example, audio signals, geographical position information of a real environment, and the like) collection and processing, the informed consent or individual consent of a personal information subject needs to be obtained in strict accordance with the requirements of relevant regional laws and regulations, and the subsequent data use and processing behavior is carried out within the scope of authorization of laws and regulations and the personal information subject.

Based on the foregoing description, an embodiment of this application provides an audio processing method. The audio processing method may be performed by the computer device (a terminal or a server) mentioned above, or may be performed by a terminal and a server jointly. For ease of description, the following is described by using an example in which a computer device performs the audio processing method. Referring to FIG. 2, the audio processing method may include the following operations S201 to S203.

S201. Obtain a real audio signal and a virtual audio signal in an augmented reality scene.

The real audio signal is an audio signal acquired in a real environment on which the augmented reality scene is based. The real environment on which the augmented reality scene is based is a real physical environment in which a user is located, sounds in the real environment may be acquired to obtain a corresponding real audio signal, and the audio signal acquired in the real environment can represent a real world sound, including but not limited to, a speech sound of a speaker in the real environment, a sound played by a speaker in the real environment, environmental noise in the real environment, and the like.

In an implementation, sounds generated by a sound resource in the real environment may be acquired through an audio acquisition device having a stereo acquisition function, to obtain the real audio signal in the augmented reality scene. The audio acquisition device includes, but not limited to, a stereo microphone, a stereo recording functional headset, and the like. The external real world sound may be acquired through the audio acquisition device having a stereo acquisition function, to obtain a directional and three-dimensional sound signal. For example, the real world sound may be acquired in real time through the stereo recording functional headset to obtain a stereo signal. For the stereo recording headset, referring to FIG. 3, and microphones are deployed around left and right ears of the headset to respectively left and right sound signals. Further, the acquired sound signals are processed through digital signals and are mixed with stereo in a virtual environment, and a sound-mixed signal is outputted through the headset (or a combination of two or more speakers), to give full play to a spatial sound effect of the sound-mixed signal. In this way, an auditory scene of an actual site can be played and restored, a listener can clearly identify orientations, senses of distance, and movement tracks of different acoustical objects, and the listener can also hear sounds with a stronger three-dimensional sense and a stronger sense of spatial layering brought by the spatial sound effect, so that the listener feels a sense of wrapped by sounds in all directions, and the listener has an immersive auditory experience of being in an actual environment. In another implementation, the real audio signal in the augmented reality scene may alternatively be acquired through a routine audio acquisition device.

The virtual audio signal is an audio signal constructed in a virtual environment on which the augmented reality scene is based. The virtual environment on which the augmented reality scene is based is a simulated environment completely generated by a device. Sounds in the virtual environment may be acquired to obtain a corresponding virtual audio signal, the sounds in the virtual environment are sounds constructed by the device, and the sounds are generated due to sound generation by objects in a simulated real environment. The acquired virtual audio signal can represent a constructed virtual world sound, for example, a speech sound of a virtual character in a virtual game scene, a simulated sound of flowing water, a simulated bird sound, a simulated sound of singing, and the like. The virtual world sound may alternatively be a stereo, so that a three-dimensional sense of the sound can be increased. That is, the audio signal constructed in the virtual environment may be understood as an audio signal obtained by performing acquisition on the sounds in the virtual environment.

The computer device may acquire the real audio signal and the virtual audio signal in the augmented reality scene in real time, or the computer device may obtain, from a database, a real audio signal and a virtual audio signal that are pre-acquired and stored in the database. For example, in an augmented reality scene in which a user plays a multiplayer game through an augmented reality device, the augmented reality device used by the user may acquire a speech sound of the user and other sounds in a real physical environment in which the user is located in real time, and may further acquire speech sounds of other players, to obtain a real audio signal. In addition, sounds in a virtual game world may be further acquired to obtain a virtual audio signal. Subsequently, sound mixing may be performed on the real audio signal and the virtual audio signal according to a set target sound mixing mode, so that the player can hear a sound with a corresponding sound mixing effect represented by the sound-mixed signal, thereby bringing a more immersive game experience.

S202. Determine a plurality of sound mixing modes configured for the augmented reality scene, and select one sound mixing mode from the plurality of sound mixing modes as a target sound mixing mode.

The computer device may determine at least two sound mixing modes (that is, the plurality of sound mixing modes) configured for the current augmented reality scene. In an implementation, sound mixing modes configured for different augmented reality scenes may be different, which specifically may be embodied at a quantity of sound mixing modes and a specific difference between the sound mixing modes. For example, five sound mixing modes are configured to an AR scene S1, and only three sound mixing modes are configured to an AR scene S2. For another example, three sound mixing modes are configured for an AR scene S1 and three sound mixing modes are configured for an AR scene S2, but there is only one same sound mixing mode. In another implementation, a same sound mixing mode may be configured for different augmented reality scenes. That is, a plurality of same sound mixing modes may be uniformly configured for different augmented reality scenes, so that the plurality of sound mixing modes can be universal in different augmented reality scenes. For example, five sound mixing modes are uniformly configured and may be used in various augmented reality scenes. The plurality of sound mixing modes may be configured for the augmented reality scene in advance, and after the plurality of sound mixing modes are configured for the augmented reality scene, a correspondence between the augmented reality scene and the plurality of sound mixing modes may be stored in a storage space, so that when the computer device performs operation S202, the computer device may determine the plurality of sound mixing modes configured for the augmented reality scene based on the correspondence. The correspondence may include, but not limited to, a scene identifier (for example, a scene name) of the augmented reality scene and mode identifiers (for example, mode names or mode reference numerals) of the plurality of sound mixing modes configured for the augmented reality scene.

Different sound mixing modes are configured for realizing different sound mixing effects between the real audio signal and the virtual audio signal. A sound mixing effect is an effect of sound mixing in auditory perception, which may reflect a volume magnitude relationship between a virtual world sound (that is, a sound corresponding to the virtual audio signal) and a real world sound (a sound corresponding to the real audio signal). In an implementation, the plurality of sound mixing modes configured for the augmented reality scene may include: \textcircled{1} a real-closed sound mixing mode (or may be referred to as a real world sound-closed mode); \textcircled{2} a virtual-closed sound mixing mode (or may be referred to as a virtual world sound-closed mode); \textcircled{3} a strong virtual sound mixing mode (or may be referred to as a weak real world sound mode or a weak real sound mixing mode); \textcircled{4} a strong real sound mixing mode (or may be referred to as a strong real world sound mode or a weak virtual sound mixing mode); and \textcircled{5} an equivalent sound mixing mode (or may be referred to as a real and virtual sound equivalent mode). Sound mixing effects realized in these sound mixing modes are different. For example, in the real-closed sound mixing mode (or the virtual-closed sound mixing mode), the real audio signal corresponding to the real world sound (or the virtual audio signal corresponding to the virtual world sound) is not outputted, to shield the real world sound (or the virtual world sound) in the sound mixing effect. In the strong virtual sound mixing mode (that is, the weak real sound mixing mode), a final sound mixing effect is that a volume of the virtual world sound is greater than a volume of the real world sound. That is, the strong virtual sound mixing mode (the weak real sound mixing mode) is a sound mixing mode causing the volume of the virtual world sound to be greater than the volume of the real world sound after sound mixing. In the strong real sound mixing mode (that is, the weak virtual sound mixing mode), a final sound mixing effect is that the volume of the real world sound is greater than the volume of the virtual world sound. That is, the strong real sound mixing mode (that is, the weak virtual sound mixing mode) is a sound mixing mode causing the volume of the real world sound to be greater than the volume of the virtual world sound after sound mixing. In the equivalent sound mixing mode, the real world sound and the virtual world sound that are heard after sound mixing are in an equivalent level (that is, the volume of the real world sound is the same as the volume of the virtual world sound), the user feels that the two sounds are harmonically integrated in hearing. That is, the equivalent sound mixing mode is a sound mixing mode causing the volume of the real world sound to be the same as the volume of the virtual world sound after sound mixing.

In an embodiment, the real audio signal is obtained by acquiring the real world sound, which may include some environmental noise and affects subsequent processing on the real audio signal, so that before sound mixing processing is performed, noise reduction may be performed on the real audio signal to filter environmental noise interference in the real audio signal as much as possible, to obtain a denoised real audio signal, and the denoised real audio signal may participate in subsequent related processing with the virtual audio signal. Therefore, different sound mixing modes may be configured for the augmented reality scene, for example, the real world sound-closed mode, the weak real world sound mode, the real and virtual sound equivalent mode, the strong real world sound mode, and the virtual world sound-closed mode that are mentioned above, to provide selectable sound mixing modes to realize a required sound mixing effect.

Specifically, after the plurality of sound mixing modes configured for the augmented reality scene are determined, one sound mixing mode may be selected from the plurality of sound mixing modes, and the selected sound mixing mode may be used as the target sound mixing mode and configured for sound mixing processing on the real audio signal and the virtual audio signal. For example, the plurality of sound mixing modes include a sound mixing mode R1, a sound mixing mode R2, and a sound mixing mode R3, and if the sound mixing mode R3 is selected, the sound mixing mode R3 may be used as the target sound mixing mode. The target sound mixing mode may be selected according to a requirement of the user in the augmented reality scene, or may be selected by automatically analyzing a requirement of the augmented reality scene for sound integration.

In an implementation, the augmented reality scene includes an augmented reality device, and the augmented reality device can be not only configured to acquire the real audio signal, but also may be configured to assist the computer device in determining the target sound mixing mode. In a specific implementation, the target sound mixing mode may be determined by directly operating a physical key of the augmented reality device. In another specific implementation, the augmented reality device may be associated with an augmented reality application, the mode identifiers of the plurality of sound mixing modes configured for the AR scene may be displayed on an application interface of the augmented reality application, and one sound mixing mode may be selected through a select operation on the mode identifiers on the application interface as the target sound mixing mode.

S203. Perform sound mixing processing on the real audio signal and the virtual audio signal according to the target sound mixing mode to obtain a sound-mixed signal; and outputting the sound-mixed signal.

Different sound mixing modes also determine a sound mixing manner between the real audio signal and the virtual audio signal, and the sound mixing manner specifically relates to volume adjustment on the audio signals and a mixing manner. The sound-mixed signal obtained by performing sound mixing processing according to the sound mixing manner indicated by the target sound mixing mode has a sound mixing effect corresponding to the target sound mixing mode, and through the sound mixing processing on the real audio signal and the virtual audio signal, the real audio signal and the virtual audio signal that are in different tracks may be integrated into a sound-mixed signal in a track. The sound mixing processing may correspond to integration of the real world sound and the virtual world sound, and the corresponding sound mixing effect may correspond to an integration effect between the real world sound and the virtual world sound.

In an implementation, after the sound-mixed signal is obtained, the computer device may output the sound-mixed signal in the augmented reality scene in real time. By performing sound mixing on the real audio signal and the virtual audio signal in the AR scene and outputting the sound-mixed signal, the listener may feel a sound effect associated with a virtual object in the virtual world, thereby bringing a more immersive and realistic auditory experience. Based on the foregoing processing procedure, the audio processing method provided in this application shields or does not shield a sound source in the real world and can further perform corresponding processing on an audio signal in the real world and an audio signal in the virtual world, and finally integrate the two audio signals to realize sound integration.

According to the audio processing method provided in the embodiments of this application, a real audio signal and a virtual audio signal in an augmented reality scene may be obtained, where the real audio signal is an audio signal acquired in a real environment on which the augmented reality scene is based, and the virtual audio signal is an audio signal constructed in a virtual environment on which the augmented reality scene is based. A plurality of sound mixing modes configured for the augmented reality scene are determined, and one sound mixing mode is selected from the plurality of sound mixing modes as a target sound mixing mode, where different sound mixing modes may be configured for realizing different sound mixing effects between the real audio signal and the virtual audio signal, thereby bringing different auditory experiences. By determining the plurality of sound mixing modes for the augmented reality scene, diversified selections can be provided for setting of the target sound mixing mode, and the target sound mixing mode can be flexibly set, so that various scenes in which the real audio signal and the virtual audio signal need to be mixed can be adapted to, and some personalized sound mixing requirements of the user can also be met. Sound mixing processing is performed on the real audio signal and the virtual audio signal according to the target sound mixing mode to obtain a sound-mixed signal, and the sound-mixed signal is outputted. Since the target sound mixing mode can realize a corresponding sound mixing effect between the real audio signal and the virtual audio signal, by controlling sound mixing processing on the real audio signal and the virtual audio signal in the target sound mixing mode, integration of sounds in the real world and sounds in the virtual world on which the augmented reality scene is based may be realized in an auditory dimension, so that sound integration in the augmented reality scene is increased in the auditory aspect, an integration capability in the augmented reality scene is enriched, and the obtained sound-mixed signal also has the sound mixing effect corresponding to the target sound mixing mode. The sound-mixed signal is finally outputted, so that the user can feel a sound integration effect in the augmented reality scene more intuitively, thereby improving an immersed sense of the user in the augmented reality scene.

Based on the method embodiment shown in FIG. 2, an embodiment of this application further provides a more detailed audio processing method. In this embodiment of this application, description is mainly provided by using an example in which a computer device performs the audio processing method. Referring to FIG. 4, the audio processing method may include the following operations S401 to S404.

S401: Obtain a real audio signal and a virtual audio signal in an augmented reality scene.

S402: Determine a plurality of sound mixing modes configured for the augmented reality scene, and select one sound mixing mode from the plurality of sound mixing modes as a target sound mixing mode.

In an embodiment, when selecting one sound mixing mode from the plurality of sound mixing modes as the target sound mixing mode, the computer device may specifically perform the following content: obtaining a mode configuration operation, and selecting one sound mixing mode from the plurality of sound mixing modes as the target sound mixing mode according to the mode configuration operation.

The mode configuration operation obtained by the computer device includes: \textcircled{1} a select operation for a plurality of mode identifiers displayed in an augmented reality application, where one mode identifier corresponds to one sound mixing mode; or \textcircled{2} a mode select operation performed by operating a physical key on an augmented reality device.

For the first type of mode configuration operation, the augmented reality application is an application program (APP) configured for providing an interaction operation that can act on the augmented reality scene, and the augmented reality application may be installed in the computer device (for example, a mobile terminal) or may be installed in another computer device connected to the computer device performing the audio processing method, for example, a mobile terminal connected to an AR headset, where a connection manner includes, but not limited to, a wired connection (for example, a connection through a data line) or a wireless connection (for example, a Bluetooth connection). The augmented reality application may provide an application interface to display mode identifiers respectively corresponding to the plurality of sound mixing modes, where different sound mixing modes correspond to different mode identifiers, and each mode identifier supports selection. The select operation for the plurality of mode identifiers displayed in the augmented reality application may be a select operation for a mode identifier on the application interface provided by the augmented reality application, for example, a click operation for the mode identifier or a preset gesture operation. The select operation may be configured for indicating a mode identifier selected by the user and represents a sound mixing mode that the user needs to use, and the computer device may further determine a sound mixing mode corresponding to the mode identifier from the plurality of sound mixing modes based on the mode identifier in the select operation and use the sound mixing mode as the target sound mixing mode. In an implementation, the user may alternatively input a mode identifier on the application interface of the augmented reality application, and the computer device may select a corresponding sound mixing mode based on the inputted mode identifier as the target sound mixing mode. For example, FIG. 5A shows a schematic diagram of a scenario of setting a target sound mixing mode, where 501 marks an application interface of an augmented reality application, the application interface displays mode identifiers respectively corresponding to five sound mixing modes, and each mode identifier can be selected. When any mode identifier is confirmed and selected, the computer device determines a sound mixing mode corresponding to the selected mode identifier as the target sound mixing mode.

In this manner, by providing the augmented reality application, the mode identifier of the sound mixing mode may be visually displayed to the user, so that the user has an initiative in selecting the target sound mixing mode for the augmented reality scene. In this way, the user may no longer passively receive a final sound-mixed signal, but can select a sound mixing mode according to a point of interest of the user and is not limited to a fixed sound mixing mode, thereby better meeting a requirement of the user for personalizing sound mixing in the augmented reality scene.

For the second mode configuration operation, the augmented reality scene includes an augmented reality device, and the augmented reality device is a computer device configured to provide an interaction operation that can act on the augmented reality scene, for example, an AR headset. The augmented reality device includes a physical key, and the physical key may be operated by the user to control selection of the sound mixing mode. In some embodiments, each time the physical key is operated, one mode select operation may be generated to enable the computer device to select the target sound mixing mode from the plurality of sound mixing modes. For example, a required target sound mixing mode may be manually configured through a button switch (a physical key) on the AR headset, and each time the button switch on the AR headset is pressed, it indicates to switch a current sound mixing mode, thereby obtaining a new sound mixing mode. In this manner, selection of the sound mixing mode is implemented through the physical key provided by the augmented reality device, so that the user can have a more realistic sense of operation. If the first mode configuration operation is invalid, the mode select operation through the physical key may also be used as a backup to select the target sound mixing mode. In the augmented reality scene, both the foregoing two mode configuration operations may be used to determine the target sound mixing mode, and the two operations may be used as backups of each other to ensure normal selection of the user on the sound mixing mode.

In another embodiment, the foregoing manners of selecting the sound mixing mode are all manual manners provided for the user, to enable the selected sound mixing mode to better match the augmented reality scene, so as to obtain a more suitable sound mixing effect. Alternatively, the target sound mixing mode may be automatically determined without user's participation. When selecting one sound mixing mode from the plurality of sound mixing modes as the target sound mixing mode, the computer device specifically may perform the following operation \textcircled{1} and operation \textcircled{2}, to automatically determine the target sound mixing mode according to geographical position information of a real environment.

Operation \textcircled{1}. Determine geographical position information of a real environment on which the augmented reality scene is based, and determine an environment type of the real environment according to geographical position information.

The geographical position information of the real environment may be configured for describing a relative spatial relationship between geographical matters in the real environment. The geographical position information may be represented through specific latitudes and longitudes, or may be represented through a specific position name, which is not limited in this application. The geographical position information of the real environment may be determined, for example, obtained by positioning the real environment in which the user is located by using a global positioning system (GPS) included in an augmented reality device used by the user. For example, the geographical position information obtained through GPS positioning is: City A-District C-Street D Road 58-xx Opera theater. Due to the characteristic that the geographical position information can describe the real environment in detail, the environment type of the real environment may be determined by analyzing the geographical position information. According to an environment attribute, the environment type of the real environment on which the augmented reality scene is based includes, but not limited to, an indoor environment and an outdoor environment. The indoor environment is, for example, an opera theater, a movie theater, a traveling vehicle, a shopping mall, or the like; and the outdoor environment is, for example, a street, a playground, seaside, or the like. For example, if the geographical position information is xx music hall, it may be determined that the environment type of the real environment is an indoor environment.

Operation \textcircled{2}. Select one sound mixing mode from the plurality of sound mixing modes as the target sound mixing mode according to a requirement of the determined environment type for sound integration.

The requirement for sound integration herein is a requirement for integrating a real world sound and a virtual world sound in the augmented reality scene by mixing the real audio signal and the virtual audio signal, which may reflect a volume magnitude relationship between the virtual world sound (that is, a sound corresponding to the virtual audio signal) and the real world sound (a sound corresponding to the real audio signal). Requirements of different environment types for sound integration may be different. For example, since the indoor environment has less noise interference relative to the outdoor environment, the outdoor environment has a requirement for a higher definition of the virtual world sound and needs to suppress the real world sound, and the indoor environment may less suppress the real world sound, so that the real world sound and the virtual world sound may be equivalent during integration. The computer device may record information configured for indicating a requirement of each environment type for sound integration in a storage space in advance, so that when performing operation \textcircled{2}, the computer device may determine a requirement of a corresponding environment type for sound integration based on the information recorded in advance.

The requirement of the corresponding environment type for sound integration represents a requirement of the real environment for sound integration, the requirement for sound integration may be configured for indicating a specific integration effect, and different sound mixing modes are configured for realizing different sound mixing effects. Therefore, one suitable sound mixing mode may be selected from the sound mixing modes as the target sound mixing mode based on the requirement of the corresponding environment type for sound integration. For example, since the outdoor environment has a requirement for a higher definition of the virtual world sound, a strong virtual world sound mode may be selected for sound mixing processing, so that the virtual world sound is clearer and is more likely to be heard.

According to the foregoing operation \textcircled{1} and operation \textcircled{2}, the environment type of the real environment is automatically analyzed according to the geographical position information of the real environment, and the target sound mixing mode is automatically selected based on the requirement of the environment type for sound integration. The whole process can automatically and intelligently determine the target sound mixing mode for performing sound mixing processing on the real audio signal and the virtual audio signal, and realize a final sound mixing effect that the target sound mixing mode matches the requirement of the corresponding environment type for sound integration, thereby further improving an immersed sense and a sense of reality brought by sound integration in the augmented reality scene.

In an embodiment, to enhance an auditory perception experience in the augmented reality scene, before volume adjustment is performed on the audio signals, sound effect processing may be performed on the real audio signal and the virtual audio signal, where the sound effect processing includes, but not limited to, one or more of the following: reverberation processing and balancing processing. The reverberation processing may add reflected sounds of a specific ratio and attenuation to an audio signal to change a feeling of audio. Through the reverberation processing, a natural sense and a three-dimensional sense of audio can be increased, so that the audio is heard richer and more layered, so that a strong sense of the environment can be felt through a sound after the reverberation processing. For example, a natural effect in the real environment such as a room or a hall can be simulated through reverberation. The balancing processing may change energy distribution of an audio signal at different frequencies to adjust tonal and spectral balance of audio, which can enhance or weaken a volume of a frequency band, so that the audio is heard brighter, clearer, softer, or more dynamic. For example, when bass in sounds of a song is not strong and a strength of the bass needs to be enhanced, frequency distribution of the audio may be adjusted through balancing processing to enhance a low-frequency part, so that a listener can feel a richer music effect. In a specific implementation, sound effect processing may be performed on the audio signal in the augmented reality scene in the following manner 1 and manner 2.

Manner 1: Determine a scene type of the augmented reality scene, and perform sound effect processing on the real audio signal and the virtual audio signal in the augmented reality scene respectively according to a requirement of the scene type for a sound effect.

Specifically, the scene type of the augmented reality scene may be determined based on a service related to the augmented reality scene. That is, the computer device may determine the service related to the augmented reality scene, to determine the scene type of the augmented reality scene based on a correspondence between services and scene types. For example, if the service related to the augmented reality scene is a multiplayer online game, the scene type is a game scene. For another example, if the service related to the augmented reality scene is a social service of an online chorus, the scene type may be a social scene. Different scene types have different requirements on the sound effect so that sound effect processing matching the requirement of the scene type for the sound effect may be performed on the obtained real audio signal and virtual audio signal. For example, if the scene type of the augmented reality scene is a game scene and the requirement of the game scene for the sound effect is that sounds need to be dynamic and have a sense of environment, reverberation processing may be performed on the real audio signal and the virtual audio signal, and balancing processing may be performed by using a relatively small parameter or may not be performed, thereby bringing higher reverberation and smaller balance, and increasing an environmental atmosphere of the game scene. The computer device may record a requirement of each scene type for the sound effect in advance, so that the requirement of the scene type of the augmented reality scene for the sound effect may be determined based on the information recorded in advance after the scene type of the augmented reality scene is determined, and sound effect processing is performed on the real audio signal and the virtual audio signal in the augmented reality scene respectively according to the requirement.

Manner 2: Obtain the environment type of the real environment on which the augmented reality scene is based, and perform sound effect processing on the real audio signal and the virtual audio signal in the augmented reality scene respectively according to a requirement of the environment type of the real environment for a sound effect.

Specifically, the environment type of the real environment may be determined based on the geographical position information of the real environment. Different environment types may have different requirements for the sound effect. For example, when the environment type is an outdoor environment, it requires a higher definition and a higher sense of dynamic of sounds, so that the sense of environment may not be so strong; and when the environment type is an indoor environment, it requires a better three-dimensional sense and a better sense of layering of sounds. In this way, the computer device may perform balancing processing on the real audio signal and the virtual audio signal and does not need to perform reverberation processing. For another example, when the environment type is an indoor environment, a requirement for a sense of environment becomes higher and a requirement for a sense of dynamic may be low, so that reverberation processing may be performed on the real audio signal and the virtual audio signal to increase the sense of environment, and there is no need to perform balancing processing. As can be seen, sound effect processing performed by the computer device may match the requirement of the environment type of the real environment for a sound effect, to finally realize the sound effect required by the corresponding environment type.

In the foregoing two manners, sound effect processing performed on the audio signal in the augmented reality scene can be automatically determined according to the scene type of the augmented reality scene or the requirement of the environment type of the real environment on which the augmented reality scene is based for a sound effect, so that the audio signal on which sound effect processing is performed meets a corresponding sound effect requirement and matches the augmented reality scene, thereby bringing better experience.

In an embodiment, each sound mixing mode in the plurality of sound mixing modes has a mode identifier, the mode identifier may be a mode value or a sequence number and may be configured for uniquely identifying the sound mixing mode, and each mode identifier corresponds to one balancing parameter group required for performing balancing processing; and the balancing parameter group corresponding to any mode identifier includes: a first volume balancing parameter of the virtual audio signal in a corresponding sound mixing mode and a second volume balancing parameter of the real audio signal in the corresponding sound mixing mode. Corresponding balancing parameter groups in different sound mixing modes may be different, which may be embodied in a difference between balancing parameters. For example, a second volume balancing parameter in a balancing parameter group in the strong real sound mixing mode is greater than a second volume balancing parameter in a balancing parameter group in the strong virtual sound mixing mode. Through the volume balancing parameters, a frequency of the audio signal may be controlled to enable the audio signal to represent different balancing effects, for example, to enable the audio signal to represent a powerful, soft, or bright and clear sound effect.

Based on the balancing parameter group configured for the sound mixing mode, before performing sound mixing processing on the real audio signal and the virtual audio signal according to the target sound mixing mode to obtain a sound-mixed signal, the computer device may further perform the following operations: obtaining a balancing parameter group corresponding to the mode identifier of the target sound mixing mode. One mode identifier corresponds to one balancing parameter group, so that the required balancing parameter group is obtained through querying according to the mode identifier of the target mode. In an implementation, the balancing parameter group may be obtained through querying from a mapping data table, and the mapping data table includes a plurality of mode identifiers and a balancing parameter group corresponding to each mode identifier. Then, balancing processing is performed on the virtual audio signal by using the first volume balancing parameter in the obtained balancing parameter group, and balancing processing is performed on the real audio signal by using the second volume balancing parameter in the obtained balancing parameter group. For example, if the target sound mixing mode is a strong real sound mixing mode, to obtain a clearer sound, a balancing parameter group of the strong real sound mixing mode may be obtained, and the first volume balancing parameter may be greater than the second volume balancing parameter in the balancing parameter group, so that clarity of a real world sound is enhanced after balancing processing. In an implementation, a balanced virtual audio signal and a balanced real audio signal may be respectively obtained through balancing processing, so that when performing sound mixing on the virtual audio signal and the real audio signal according to the target sound mixing mode, the computer device specifically may perform sound mixing on the balanced virtual audio signal and the balanced real audio signal according to the target sound mixing mode to obtain a final sound-mixed signal.

S403: Perform volume adjustment on the real audio signal and the virtual audio signal respectively according to the target sound mixing mode, to obtain a real audio signal after volume adjustment and a virtual audio signal after volume adjustment.

Volume adjustment manners of the real audio signal and the virtual audio signal may be respectively determined based on any sound mixing mode. Different sound mixing modes may correspond to different parameters for performing corresponding volume adjustment. In the corresponding target sound mixing mode, the real audio signal after volume adjustment and the virtual audio signal after volume adjustment may be obtained through volume adjustment. In terms of volumes, the real audio signal after volume adjustment may be the same as or different from the originally obtained real audio signal, and the virtual audio signal after volume adjustment may also be the same as or different from the originally obtained virtual audio signal. For example, if the target sound mixing mode is a strong real world sound mode, a volume of the real audio signal may be increased, and an original volume of the virtual audio signal is kept or a volume of the virtual audio signal is reduced.

The volume of the audio signal is a sound amplitude subjectively sensed by a listener and may be also referred to as loudness. A volume magnitude may be determined by an amplitude (or may be referred to as a vibration amplitude, an amplitude value, or an amplitude) of the audio signal and a distance between the listener and a sound source, where a larger amplitude indicates larger loudness, and a smaller distance between the listener and the sound source indicates larger loudness. Therefore, during adjustment of the volume of the audio signal, the amplitude of the audio signal may be adjusted, or a distance between an augmented reality device configured to acquire the real audio signal and a sound source may be adjusted, or the loudness of the audio signal is directly adjusted. In this embodiment of this application, a manner of adjusting the amplitude of the audio signal to adjust the volume of the audio signal is used.

In an embodiment, the volume of the audio signal changes along with an amplitude change of the audio signal. The amplitude of the audio signal is positively correlated with the volume of the audio signal, the volume of the audio signal may increase as the amplitude of the audio signal increases, or may decrease as the amplitude of the audio signal decreases. When performing volume adjustment on the real audio signal and the virtual audio signal respectively according to the target sound mixing mode, the computer device specifically may perform content described in (1) to (4) below, and volume adjustment on the real audio signal and volume adjustment on the virtual audio signal may be implemented by using logic shown in (1) to (4) below. The following content describes a principle of performing volume adjustment on an audio signal in the augmented reality scene by using any audio signal of the real audio signal and the virtual audio signal as an example.

(1) Traverse the real audio signal and the virtual audio signal, use a currently traversed audio signal as a current audio signal, and obtain an amplitude constraint parameter of the current audio signal in the target sound mixing mode.

The traversed audio signal may be the real audio signal or the virtual audio signal. If the current audio signal is the real audio signal, volume adjustment on the real audio signal may be implemented, or if the current audio signal is the virtual audio signal, volume adjustment on the virtual audio signal may be implemented.

The amplitude constraint parameter of the current audio signal is a parameter required for constraining adjustment on an amplitude of the current audio signal in the target sound mixing mode; and amplitude constraint parameters corresponding to the current audio signal in different sound mixing modes may be different, and an amplitude constraint parameter of the real audio signal in the target sound mixing mode and an amplitude constraint parameter of the virtual audio signal in the target sound mixing mode may also be the same or different.

In an embodiment, the plurality of sound mixing modes include at least two of the following: a strong real sound mixing mode, a strong virtual sound mixing mode, an equivalent sound mixing mode, a real-closed sound mixing mode, and a virtual-closed sound mixing mode; and the amplitude constraint parameter of any audio signal is positively correlated with a volume of a corresponding audio signal after volume adjustment. A larger amplitude constraint parameter indicates a larger volume of any audio signal after volume adjustment, and a smaller amplitude constraint parameter indicates a smaller volume of any audio signal after volume adjustment, where the audio signal herein may be the real audio signal or the virtual audio signal.

In different sound mixing modes, magnitude relationships between the amplitude constraint parameter of the real audio signal and the amplitude constraint parameter of the virtual audio signal may be different, to realize different sound mixing effects. Specifically, the following content is included: \textcircled{1} In the strong real sound mixing mode, the amplitude constraint parameter of the real audio signal and the amplitude constraint parameter of the virtual audio signal are both valid values, and the amplitude constraint parameter of the real audio signal is greater than the amplitude constraint parameter of the virtual audio signal. \textcircled{2} In the strong virtual sound mixing mode, the amplitude constraint parameter of the real audio signal and the amplitude constraint parameter of the virtual audio signal are both valid values, and the amplitude constraint parameter of the virtual audio signal is greater than the amplitude constraint parameter of the real audio signal. \textcircled{3} In the equivalent sound mixing mode, the amplitude constraint parameter of the real audio signal and the amplitude constraint parameter of the virtual audio signal are both valid values, and the amplitude constraint parameter of the virtual audio signal is equal to the amplitude constraint parameter of the real audio signal. \textcircled{4} In the real-closed sound mixing mode, the amplitude constraint parameter of the real audio signal is an invalid value, and the amplitude constraint parameter of the virtual audio signal is a valid value. \textcircled{5} In the virtual-closed sound mixing mode, the amplitude constraint parameter of the real audio signal is a valid value, and the amplitude constraint parameter of the virtual audio signal is an invalid value. The valid value mentioned above is a parameter value that enables an audio signal to be validly outputted, for example, a value greater than 0; and the invalid value is a parameter value enables an audio signal to be invalidly outputted, for example, 0. When the amplitude constraint parameter of any audio signal is an invalid value, it indicates that the corresponding audio signal is not outputted.

For example, the amplitude constraint parameter of any audio signal may include a target amplitude (or may be referred to as a target dB value) and a maximum gain value. In the strong real sound mixing mode, a target dB value of the real audio signal is greater than a target dB value of the virtual audio signal, and a maximum gain value of the real audio signal is greater than a maximum gain value of the virtual audio signal, to realize an objective that a volume of a virtual world sound is less than a volume of a real world sound after final sound mixing. In the strong virtual sound mixing mode, a target dB value of the real audio signal is less than a target dB value of the virtual audio signal, and a maximum gain value of the real audio signal is less than a maximum gain value of the virtual audio signal, to realize an objective that a volume of a virtual world sound is greater than a volume of a real world sound after final sound mixing. In the equivalent sound mixing mode, a target dB value of the real audio signal is equal to a target dB value of the virtual audio signal, and a maximum gain vale of the real audio signal is equal to a maximum gain value of the virtual audio signal, so that a real world sound and a virtual world sound heard after final sound mixing are in an equivalent level, and the user feels that the two sounds are harmonically integrated in hearing. Corresponding amplitude constraint parameters in the foregoing sound mixing modes are all valid values, so that a sound-mixed signal obtained by performing sound mixing on audio signals after volume adjustment can be validly outputted, to ensure that a corresponding sound mixing effect is realized. In the real-closed sound mixing mode (or the virtual-closed sound mixing mode), the amplitude constraint parameter of the real audio signal (or the virtual audio signal) is an invalid value. For example, the maximum gain value of the real audio signal (or the virtual audio signal) is 0, which indicates that a corresponding input sound signal (an input signal corresponding to the real-closed sound mixing mode is the real audio signal, and an input signal corresponding to the virtual-closed sound mixing mode is the virtual audio signal) is multiplied by 0, that is, a corresponding sound signal is not outputted.

As can be seen, in different sound mixing modes, due to different amplitude constraint parameters, volume adjustment effects of the audio signal in the augmented reality scene are different, thereby bringing different sound mixing effects. The target sound mixing mode may be selected from at least two of the foregoing sound mixing modes, to meet a required sound mixing effect.

In an embodiment, when obtaining the amplitude constraint parameter of the current audio signal in the target sound mixing mode, the computer device specifically may perform the following operation 1.1 to operation 1.4.

Operation 1.1: Obtain a preset mapping table.

The preset mapping table includes a plurality of mode identifiers and a parameter group mapped from each mode identifier; and one mode identifier is configured for identifying one sound mixing mode, the mode identifier may be a mode value, for example, a digital sequence number or a mode name, and the mode identifier may be configured for uniquely identifying the sound mixing mode. Different mode identifiers represent different sound mixing modes, so that different sound mixing effects are realized as required based on different sound mixing modes. In addition, different mode identifiers may also represent different parameter groups mapped from the mode identifiers, which specifically may be embodied in a difference between amplitude constraint parameter values included in the parameter groups. The mode identifier may be in a one-to-one mapping relationship with the parameter group, and the parameter group mapped from any mode identifier includes: a first amplitude constraint parameter of the virtual audio signal in a sound mixing mode identified by a corresponding mode identifier and a second amplitude constraint parameter of the real audio signal in the sound mixing mode identified by the corresponding mode identifier. The first amplitude constraint parameter and the second amplitude constraint parameter may include parameters of a same type, but specific values of the parameters may be different, so that a sound mixing effect required by the sound mixing mode is realized. For a specific form of the preset mapping table, reference may be made to an example shown in Table 1:

TABLE 1

| Sound | First amplitude | Second amplitude |
|---|---|---|
| mixing mode | constraint parameter | constraint parameter |
| Strong real sound | Target dB value: 20 | Target dB value: 50 |
| mixing mode | Maximum gain value: 3 | Maximum gain value: 8 |
| Weak real sound | Target dB value: 60 | Target dB value: 40 |
| mixing mode | Maximum gain value: 9 | Maximum gain value: 4 |
| Equivalent sound | Target dB value: 30 | Target dB value: 30 |
| mixing mode | Maximum gain value: 5 | Maximum gain value: 5 |
| Real-closed sound | Maximum gain value: 5 | Maximum gain value: 0 |
| mixing mode | Target dB value: — | Target dB value: — |
| Virtual-closed sound | Maximum gain value: 0 | Maximum gain value: 6 |
| mixing mode | Target dB value: — | Target dB value: — |

As shown above, when the sound mixing mode is the real-closed sound mixing mode or the virtual-closed sound mixing mode, the maximum gain value is 0, and the target dB value required by volume adjustment is not set since setting of the target dB value is not necessary when the maximum gain value is 0. Because gain processing may be directly performed on a corresponding audio signal according to the maximum gain value to cause the final sound-mixed signal not to output the audio signal, a sound represented by the corresponding audio signal is closed, where the closed effect herein is consistent with a sound shielding effect.

Operation 1.2: Query the preset mapping table according to a mode identifier of the target sound mixing mode. to obtain a parameter group mapped from the mode identifier of the target sound mixing mode.

In a specific implementation, the computer device may query the preset mapping table for a mode identifier that is the same as the mode identifier of the target sound mixing mode, and further use a parameter group mapped from the mode identifier obtained through querying as the parameter group mapped from the mode identifier of the target sound mixing mode. Therefore, the obtained parameter group includes: a first amplitude constraint parameter of the virtual audio signal in the target sound mixing mode and a second amplitude constraint parameter of the real audio signal in the target sound mixing mode, and a matching amplitude constraint parameter may be further selected from the parameter group based on the current audio signal being the real audio signal or the virtual audio signal, as shown by operation 1.3 and operation 1.4 below.

Operation 1.3: If the current audio signal is the virtual audio signal, select the first amplitude constraint parameter from the obtained parameter group as the amplitude constraint parameter of the current audio signal in the target sound mixing mode.

If the current audio signal is the virtual audio signal, it indicates that a current object on which volume adjustment is being performed is the virtual audio signal, so that the first amplitude constraint parameter in the obtained parameter group may be used as the amplitude constraint parameter of the current audio signal in the target sound mixing mode, to implement volume adjustment on the virtual audio signal.

Operation 1.4: If the current audio signal is the real audio signal, select the second amplitude constraint parameter from the obtained parameter group as the amplitude constraint parameter of the current audio signal in the target sound mixing mode.

If the current audio signal is the real audio signal, it indicates that a current object on which volume adjustment is being performed is the real audio signal, so that the second amplitude constraint parameter in the obtained parameter group may be used as the amplitude constraint parameter of the current audio signal in the target sound mixing mode, to implement volume adjustment on the real audio signal.

The sequence numbers carried in operations in this application does not necessarily constitute a limitation to an execution sequence. For example, operation 1.3 and operation 1.4 may be performed in parallel or may be performed in sequence. In addition, in this application, terms such as “first” and “second” are configured for distinguishing a same item or similar items with substantially a same role and function. There is no logical or temporal dependence between “first”, “second”, and “n^{th}”, and a quantity and an execution sequence are not limited.

According to the manner of obtaining the amplitude constraint parameter of the current audio signal shown in operation 1.1 to operation 1.4, a corresponding parameter group may be provided for each sound mixing mode through the preset mapping table, and the mode identifier of the sound mixing mode is unique and may be configured for distinguishing between different sound mixing modes, so that the parameter group mapped from the mode identifier of the target sound mixing mode may be quickly and accurately obtained through querying in the preset mapping table according to the mode identifier of the target sound mixing mode, and the amplitude constraint parameter required by the current audio signal may be obtained through table querying, thereby ensuring the validity and accuracy of subsequent processing while improving the processing efficiency.

(2) Perform signal level monitoring on the current audio signal to obtain a level description value of the current audio signal, where the level description value of the current audio signal is configured for indicating an amplitude of the current audio signal.

To obtain a purer signal, noise reduction may be performed on the current audio signal to obtain a current audio signal after noise reduction, and signal level monitoring is then performed on the current audio signal after noise reduction. General logic of signal level monitoring may be as follows: A level of the current audio signal may be obtained through signal level monitoring, where the level herein is a sampling point amplitude value (that is, an amplitude of a sampling point, or may be referred to as a sampling point amplitude) of the current audio signal, which may be described by using dB or an amplitude as a unit, and the sampling point amplitude value needs to be obtained through conversion by using the following formula if dB is used as a unit:

$$dB = 20 * log 10 ( \vert Sample \vert / 32768. )$$

dB represents an amplitude of a sampling point in the current audio signal and may be referred to as a level, Sample represents an amplitude of a sampling point, and |Sample| represents an absolute value of the amplitude of the sampling point.

In an embodiment, when performing the foregoing (2), the computer device may perform signal level monitoring by using the whole audio signal as a unit and does not need to perform framing on the current audio signal, so that an amplitude of each sampling point included in the current audio signal may be used as the level description value.

In another embodiment, the audio signal is a continuous jumping signal, so that a relatively stable level description value that can represent a signal amplitude need to be provided during volume adjustment. Therefore, the level description value of the current audio signal may be obtained based on the obtained level. When the computer device performs signal level monitoring on the current audio signal while performing the foregoing (2) to obtain the level description value of the current audio signal, the computer device may further perform signal level monitoring by using an audio frame as a smallest unit. A specific procedure includes content shown in operation 2.1 to operation 2.4 below.

Operation 2.1: Perform framing processing on the current audio signal to obtain K audio frames of the current audio signal, where K is an integer greater than 1.

In a specific implementation, framing processing may be performed on the current audio signal according to a preset frame length, so that an obtained frame length of any audio frame is less than or equal to the preset frame length. For example, the preset frame length is 5 milliseconds (ms), and the current audio signal is a real audio signal of 3 seconds(s), 60 audio frames may be obtained by performing framing processing on the current audio signal. To ensure the correlation between the audio frames obtained through framing, in addition to referring to the preset frame length, framing may be further performed according to a preset frame shift, where the preset frame shift is duration of an overlapped part between two adjacent audio frames, for example, 2 milliseconds. For example, FIG. 5B shows a schematic diagram of performing framing processing on a current audio signal, where the frame length of each audio frame obtained through framing is 20 milliseconds, and the frame shift is 5 milliseconds.

Operation 2.2: Traverse the K audio frames, and determine a currently traversed i^{th} audio frame, where i∈[1, K].

In a specific implementation, the K audio frames may be sequentially arranged according to a playing sequence in the current audio signal, and during traversal, the K audio frames may be sequentially traversed according to the playing sequence of the audio frames in the audio signal, to implement sequential processing on the K audio frames. The playing sequence herein may be understood as an arrangement position of the audio frame in the audio signal and may be represented by using a frame number of the audio frame, and the currently traversed i^{th} audio frame may be understood as a currently processed audio frame. For example, the real audio signal is divided into 100 audio frames whose frame numbers are respectively 1, 2, . . . , and 100, so that the real audio signal can be completely presented by playing the audio frames corresponding to the audio signal sequentially according to the frame numbers. For example, the i^{th} audio frame is a tenth audio frame in the K audio frames.

Operation 2.3: Perform signal level monitoring on the i^{th} audio frame to obtain a level description value of the i^{th} audio frame; or perform voice validity determination processing on the i^{th} audio frame, and perform signal level monitoring on the i^{th} audio frame in a case of determining that the i^{th} audio frame is a valid audio frame, to obtain a level description value of the i^{th} audio frame.

In a specific implementation, signal level monitoring may be directly performed on the i^{th} audio frame to obtain the level description value of the i^{th} audio frame. In another implementation, to avoid invalid processing, voice validity determination processing may be first performed on the i^{th} audio frame, to determine whether the i^{th} audio frame is a valid audio frame or an invalid audio frame. Signal level monitoring is further performed in a case of determining that the i^{th} audio frame is a valid audio frame. A valid audio frame is a valid voice signal, and an invalid audio frame is a useless voice signal or noise signal. The voice validity determination processing specifically may be implemented through voice activity detection (VAD), to recognize and eliminate a long-time mute period in a sound signal stream through VAD, so as to separate the valid voice signal from the useless voice signal or noise signal, so that subsequent processing on the audio signal becomes more efficient. If a VAD result is 1, it indicates that the i^{th} audio frame is a valid audio frame, that is, a valid voice signal. If the VAD result is 0, it indicates that the i^{th} audio frame is an invalid audio frame, that is, an invalid voice signal. Subsequently, signal level monitoring is only performed on the audio frame whose VAD result is 1 in the current audio signal, and signal level monitoring is not performed on the audio frame whose VAD result is 0. In this way, validity determination on the current audio signal can be implemented to determine the valid audio frame and the invalid audio frame in the current audio signal, so that a valid voice signal in the current audio signal is filtered and signal level monitoring is performed on the valid voice signal, thereby ensuring the validity of audio processing and saving processing resources required subsequently.

In an embodiment, each audio frame includes a plurality of sampling points and amplitudes of the sampling points. A specific implementation in which the computer device performs signal level monitoring on the i^{th} audio signal to obtain the level description value of the i^{th} audio frame may include the following content: performing mean calculation on the amplitudes of the sampling points in the i^{th} audio frame to obtain a signal amplitude mean of the i^{th} audio frame; and performing smoothing processing on the signal amplitude mean of the i^{th} audio frame to obtain the level description value of the i^{th} audio frame.

In a specific implementation of mean calculation, summation may be performed on the amplitudes of the sampling points in the i^{th} audio frame to obtain a sum, and averaging may be performed according to the sum and a quantity of the sampling points in the i^{th} audio frame to obtain the signal amplitude mean of the i^{th} audio frame. That is, the mean of the amplitudes of the sampling points in the audio frame may also be referred to as a frame amplitude mean. The signal amplitude mean may be described by using an amplitude as a unit or by using dB (decibel) as a unit. For example, the i^{th} audio frame is one frame of audio signal of 5 milliseconds (ms), and if the signal amplitude mean of the i^{th} audio frame is described by using an amplitude, a specific expression may be as follows:

$$\overline{y} ( i ) = \frac{{\sum }_{m = 1}^{M} \vert x ( m ) \vert}{M}$$

y̅(i) represents the signal amplitude mean of the i^{th} audio frame, where a unit is an amplitude, i represents a frame number, M is a total quantity of sampling points in the i^{th} audio frame, and x(m) represents an amplitude of an m^{th} sampling point.

If the signal amplitude mean is described by using dB as a unit, a specific expression is as follows:

$$\overline{x} ( i ) = 20 * log 10 ( \frac{\overline{y} ( i )}{32768.0} )$$

x̅(i) represents the signal amplitude mean of the i^{th} audio frame, where a unit is dB, and 20*log10(⋅) represents converting a signal amplitude mean represented by using an amplitude into a signal amplitude mean represented by using dB as a unit.

After the signal amplitude mean of the i^{th} audio frame is obtained, in an implementation, the signal amplitude mean of the i^{th} audio frame may be directly used as the level description value of the i^{th} audio frame. In another implementation, to cause a volume change of the audio signal to be more stable and reduce a sudden peak change, smoothing processing may be performed on the signal amplitude mean of the i^{th} audio frame to obtain the level description value of the i^{th} audio frame.

According to the signal level monitoring implemented in the foregoing manner, a mean of amplitudes of sampling points in an audio frame may be calculated, and the calculated mean is directly used as a level description value, or smoothing processing is performed on the calculated mean to obtain a level description value. An amplitude of an audio signal can be well represented through the mean, the stability can be further improved through smoothing processing, and the obtained level description value is conducive to processing on the current audio signal subsequently.

Because voice validity determination processing may be or may not be performed on the i^{th} audio frame, for specific logic of smoothing processing, reference may be made to content shown in the following a to c:
a: Search the K audio frames for a reference audio frame of the i^{th} audio frame.

The reference audio frame is an audio frame located before the i^{th} audio frame in the K audio frames. In addition, based on whether voice validity determination processing is performed on the i^{th} audio frame, the required reference audio frame is audio frames of different types. Specifically, the following content is included: If voice validity determination processing is not performed on the i^{th} audio frame, the reference audio frame includes an (i−1)^{th} audio frame. For example, if the i^{th} audio frame is a second audio frame, the reference audio frame may include a first audio frame. If voice validity determination processing is performed on the i^{th} audio frame, the reference audio frame includes a valid audio frame that is located before the i^{th} audio frame and closest to the i^{th} audio frame. The i^{th} audio frame is a valid audio frame determined through voice validity determination processing, a valid audio frame that is closest to the i^{th} audio frame may be or may not be adjacent to the i^{th} audio frame, which depends on whether an adjacent audio frame that is located before the i^{th} audio frame is a valid audio frame. For example, if the i^{th} audio frame is a third audio frame, and the first audio frame is a valid audio frame but the second audio frame is an invalid audio frame, the reference audio frame includes the first audio frame. However, no matter whether voice validity determination processing is performed, the reference audio frame is one frame on which signal level monitoring is performed. Based on a position of the i^{th} audio frame in the K audio frames, the computer device may or may not find the reference audio frame. Based on this, determination of the level description value may be classified into the following two cases of b and c:
b: If the reference audio frame is not found, use the signal amplitude mean of the i^{th} audio frame as the level description value of the i^{th} audio frame. Specifically, if the reference audio frame is not found, it indicates that the i^{th} audio frame is the first audio frame or a first valid audio frame in the K audio frames, and the signal amplitude mean of the i^{th} audio frame may be directly used as the level description value of the i^{th} audio frame.
c: If the reference audio frame is found, perform smoothing processing on the signal amplitude mean of the i^{th} audio frame by using a level description value of the reference audio frame, to obtain the level description value of the i^{th} audio frame. Specifically, if the reference audio frame is found, it indicates that the i^{th} audio frame is not the first audio frame nor the first valid audio frame in the K audio frames, and smoothing processing may be performed on the signal amplitude mean of the currently processed i^{th} audio frame by using the level description value of the reference audio frame, to obtain the level description value of the i^{th} audio frame.

In a specific implementation, when performing smoothing processing on the signal amplitude mean of the i^{th} audio frame by using the level description value of the reference audio frame to obtain the level description value of the i^{th} audio frame, the computer device specifically may implement this operation in the following manner: obtaining a first smoothing coefficient and a second smoothing coefficient that are required for smoothing processing, where the first smoothing coefficient is greater than the second smoothing coefficient. The first smoothing coefficient and the second smoothing coefficient may be set based on experience. For example, both the first smoothing coefficient and the second smoothing coefficient are set to values within 1. For example, the first smoothing coefficient is denoted as a (or may be referred to as a long-term smoothing coefficient), the second smoothing coefficient is denoted as b (or may be referred to a short-term smoothing coefficient), and both the first smoothing coefficient and the second smoothing coefficient are values less than 1. For example, a is 0.95, and b is 0.4. In another implementation, the first smoothing coefficient and the second smoothing coefficient may alternatively be determined based on a fluctuation degree of the i^{th} audio frame. For example, according to indication of the fluctuation degree of the i^{th} audio frame, a larger fluctuation degree of the i^{th} audio frame may indicate a larger first smoothing coefficient.

Long-term smoothing processing is performed on the signal amplitude mean of the i^{th} audio frame by using the first smoothing coefficient and the level description value of the reference audio frame, to obtain a signal amplitude mean after long-term smoothing processing. Specifically, long-term smoothing processing may be understood as smoothing processing performed by using a relatively large smoothing coefficient, and a volume change of the audio signal within a relatively long time may be smoother through long-term smoothing processing, thereby ensuring that the whole audio signal maintains a consistent amplitude level between different parts. Weighted summation may be performed on the level description value of the reference audio frame and the signal amplitude mean of the i^{th} audio frame by using the first smoothing coefficient, to obtain the signal amplitude mean after long-term smoothing processing. In a specific implementation, the first smoothing coefficient may be first used as a weight of the reference audio frame, a difference between a benchmark value and the first smoothing coefficient is used as a weight of the i^{th} audio frame, and weighted summation is then performed on the level description value of the reference audio frame and the signal amplitude mean of the i^{th} audio frame according to the weight of the reference audio frame and the weight of the i^{th} audio frame, to obtain the signal amplitude mean after long-term smoothing processing. The benchmark value is a value constraining a maximum value of the smoothing coefficient, for example, 1. In a specific process of weighted summation, summation processing may be performed on a product of the weight of the reference audio frame and the level description value of the reference audio frame and a product of the weight of the i^{th} audio frame and the signal amplitude mean of the i^{th} audio frame, to obtain the signal amplitude mean after long-term smoothing processing. A specific calculation expression is as follows:

$$xl ( i ) = a * x l ( i - 1 ) + ( 1 - a ) * \overline{x} ( i )$$

xl(i) represents the signal amplitude mean after long-term smoothing processing, a represents the first smoothing coefficient, xl(i−1) represents the level description value of the reference audio frame, that is, a signal amplitude mean after long-term smoothing processing of the (i−1)^{th} audio frame, and x̅(i) represents the signal amplitude mean of the i^{th} audio frame.

In addition, short-term smoothing processing may be further performed on the signal amplitude mean of the i^{th} audio frame by using the second smoothing coefficient and the level description value of the reference audio frame, to obtain a signal amplitude mean after short-term smoothing processing. Short-term smoothing processing herein may be understood as smoothing processing performed by using a relatively small smoothing coefficient, and a volume change of the audio signal within a relatively short time may be smoother through short-term smoothing processing, thereby ensuring that there is not an excessively large peak or distortion in the audio signal. Weighted summation may be performed on the level description value of the reference audio frame and the signal amplitude mean of the i^{th} audio frame by using the second smoothing coefficient, to obtain the signal amplitude mean after short-term smoothing processing. In a specific implementation, the second smoothing coefficient may be first used as a weight of the reference audio frame, a difference between a benchmark value and the second smoothing coefficient is used as a weight of the i^{th} audio frame, and weighted summation is then performed on the level description value of the reference audio frame and the signal amplitude mean of the i^{th} audio frame according to the weight of the reference audio frame and the weight of the i^{th} audio frame, to obtain the signal amplitude mean after short-term smoothing processing. The benchmark value is a value constraining a maximum value of the smoothing coefficient, for example, 1. In a specific process of weighted summation, summation processing may be performed on a product of the weight of the reference audio frame and the level description value of the reference audio frame and a product of the weight of the i^{th} audio frame and the signal amplitude mean of the i^{th} audio frame, to obtain the signal amplitude mean after short-term smoothing processing. A specific calculation expression is as follows:

$$xm ( i ) = b * x m ( i - 1 ) + ( 1 - b ) * \overline{x} ( i )$$

xm(i) represents the signal amplitude mean after short-term smoothing processing, b represents the second smoothing coefficient, xm(i−1) represents the level description value of the reference audio frame, that is, a signal amplitude mean after short-term smoothing processing of the(i−1)^{th} audio frame, and x̅(i) represents the signal amplitude mean of the i^{th} audio frame.

Finally, weighted summation is performed on the signal amplitude mean after long-term smoothing processing and the signal amplitude mean after short-term smoothing processing, to obtain the level description value of the i^{th} audio frame. The signal amplitude mean after long-term smoothing processing may be referred to as a long-term smoothing value, the signal amplitude mean after short-term smoothing processing may be referred to as a short-term smoothing value, and a corresponding weight coefficient may be used during weighed summation. A specific expression is as follows:

$$slm = c * x l ( i ) + ( 1 - c ) * x m ( i )$$

slm(i) represents the level description value of the i^{th} audio frame, that is, a final smoothing value determined according to the long-term smoothing value and the short-term smoothing value; and c represents the weight coefficient, for example, c is 0.5, xl(i) represents the signal amplitude mean after long-term smoothing processing, and xm(i) represents the signal amplitude mean after short-term smoothing processing.

In some embodiments, the foregoing short-term smoothing processing may also be replaced with middle-short-term smoothing processing, where middle-short-term smoothing processing may be understood as a type of smoothing processing between long-term smoothing processing and short-term smoothing processing, and a used smoothing coefficient is also between the smoothing coefficients used by the foregoing two types of smoothing processing. For example, the smoothing coefficient used by short-term smoothing processing is 0.3, the smoothing coefficient used by long-term smoothing processing is 0.9, and the coefficient used by middle-short-term smoothing processing is 0.7. In this way, in a specific processing of smoothing processing, a signal amplitude mean after middle-short-term smoothing processing may be obtained through middle-short-term smoothing processing, and weighted summation may be performed on the signal amplitude mean after middle-short-term smoothing processing and the signal amplitude mean after long-term smoothing processing to obtain the level description value of the i^{th} audio frame.

Through long-term smoothing processing and short-term smoothing processing (or middle-short-term smoothing processing) that are performed on the i^{th} audio frame, it can be ensured that an amplitude change of the audio frame with a relatively long time is more stable, and it can also be ensured that an amplitude change of the audio frame within a relatively short time is smoother, so that the final obtained level description value is a relatively stable value, which is conducive to subsequent gain processing on the audio signal.

In another specific implementation, when smoothing processing is performed on the signal amplitude mean of the i^{th} audio frame, a smoothing coefficient may be obtained, and H audio frames (that is, a previous frame to a previous H^{th} frame of the i^{th} audio frame) required for long-term smoothing processing and F audio frames (that is, the previous frame to a previous F^{th} frame of the i^{th} audio frame) required for short-term smoothing processing are sequentially selected toward the first frame based on the i^{th} audio frame. H>F, and both H and F are positive integers. For example, if the i^{th} audio frame is a fourth audio frame, a previous frame (that is, the third audio frame) may be obtained as an audio frame to which short-term smoothing processing refers, and previous three frames (including the third audio frame, the second audio frame, and the first audio frame) may be obtained as audio frames to which long-term smoothing processing refers. Long-term smoothing processing is then performed on the signal amplitude mean of the i^{th} audio frame by using the smoothing coefficient and the H audio frames, to obtain a signal amplitude mean after long-term smoothing processing, and short-term smoothing processing is performed on the signal amplitude mean of the i^{th} audio frame by using the smoothing coefficient and the F audio frames, to obtain a signal amplitude mean after short-term smoothing processing. In this manner, long-term smoothing processing may be understood as smoothing processing performed by using a relatively large quantity of audio frames, and short-term smoothing processing may be understood as smoothing processing performed by using a relatively small quantity of audio frames. The signal amplitude mean of the current i^{th} audio frame is adjusted with reference to a larger quantity of historical audio frames in long-term smoothing processing, and the signal amplitude mean of the current i^{th} audio frame is adjusted with reference to a smaller quantity of historical audio frames in short-term smoothing processing, thereby improving the stability of the audio signal represented by the audio frame.

Operation 2.4: Continue traversal until the K audio frames are all traversed to obtain the level description value of the current audio signal, where the level description value of the current audio signal includes level description values of the audio frames obtained through monitoring.

After the currently traversed i^{th} audio frame has been processed, traversal may be continued to perform processing similar to that on the i^{th} audio frame on the traversed audio frames. When signal level monitoring is directly performed, the monitored audio frames include K audio frames, and the level description value of the current audio signal is obtained, including level description values of the K audio frames. When voice validity determination is performed on the audio frame, the monitored audio frames are valid audio frames, and the level description value of the current audio signal includes level description values of J valid audio frames, where J≤K. When J<K, it indicates that an invalid audio frame exists in the K audio frames of the current audio signal, the invalid audio frame may be discarded, and a discarding manner may be delete or shield. When J=K, it indicates that the K audio frames of the current audio signal are all valid audio frames, so that the obtained level description value of the current audio signal includes the level description values of the K audio frames.

According to the foregoing operation 2.1 to operation 2.4, framing processing is performed on the current audio signal, and signal level monitoring is directly performed on each audio frame obtained through framing, so that the level description value of each audio frame is quickly obtained; and signal level monitoring may be further performed on valid audio frames after voice validity determination processing to obtain the level description values, thereby ensuring subsequent valid processing and avoid processing resources from being wasted ineffectively.

(3) Control, according to the obtained amplitude constraint parameter and the level description value of the current audio signal, a gain required by the amplitude of the current audio signal, to obtain an amplitude gain of the current audio signal.

In an implementation, the amplitude constraint parameter of the current audio signal in the target sound mixing mode (that is, the obtained amplitude constraint parameter) includes: a target amplitude and an amplitude gain threshold, where the target amplitude is an expected amplitude (a unit may be dB or an amplitude) that needs to be reached when the amplitude of the current audio signal is adjusted in the target sound mixing mode and may also be referred to as a target dB value, and the amplitude gain threshold is a gain upper limit value required for constraining volume adjustment performed on the current audio signal in the target sound mixing mode and may be configured for limiting a gain required for reaching the target amplitude, thereby avoiding improper volume adjustment, so that the amplitude gain threshold may also be referred to as a maximum gain value.

In a specific implementation, based on the foregoing amplitude constraint parameter, the computer device may perform, by using the whole current audio signal as a unit, gain prediction according to the target amplitude and the level description value of the current audio signal, and select, after obtaining a predicted amplitude gain required by the amplitude of the current signal to reach the target amplitude, a smaller value of the predicted amplitude gain and the obtained amplitude gain threshold as the amplitude gain of the current audio signal.

In another specific implementation, the current audio signal is framed into K audio frames, and the foregoing signal level monitoring performed on the current audio signal is performed by using the audio frame as a unit. In some embodiments, before signal level monitoring is performed, whether a currently processed audio frame is a valid audio frame may be further determined to obtain a level description value when the currently processed audio frame is a valid audio frame. Therefore, the level description value of the current audio signal includes level description values of J audio frames on which signal level monitoring is performed in the K audio frames, where K is an integer greater than 1 and J≤K. Based on this, the computer device can determine frame amplitude gains of audio frames on which signal level monitoring has been performed by using the audio frame as a unit. Specifically, the following operation 3.1 to operation 3.4 are included.

Operation 3.1: Traverse the J audio frames related to the level description value of the current audio signal to determine a currently traversed j^{th} audio frame, where j∈[1, J].

The J audio frames on which signal level monitoring is performed in the K audio frames may be arranged according to a playing sequence. Therefore, the computer device may traverse the J audio frames according to arrangement positions of the audio frames in the audio signal, the traversed j^{th} audio frame is an audio frame that needs to be currently processed, and the j^{th} audio frame has passed signal level monitoring and has a corresponding level description value. In an implementation, if J=K, the j^{th} audio frame may correspond to the foregoing i^{th} audio frame traversed during signal level monitoring. For example, after level monitoring is performed on the traversed first audio frame to obtain a corresponding level description value, required gain control processing may be directly performed. In another implementation, if level monitoring is performed according to whether voice validity determination processing is performed and J<K, the j^{th} audio frame is a valid audio frame, the j^{th} audio frame does not necessarily correspond to the foregoing i^{th} audio frame traversed during signal level monitoring, and the J audio frames are a plurality of audio frames with a new arrangement sequence formed after an invalid audio frame is filtered out from the K audio frames. For example, a second audio frame in the K audio frames is actually a first audio frame in the J audio frames. For a relationship between the K audio frames and the J audio frames and a relationship between the traversed i^{th} audio frame and the j^{th} audio frame, as shown in FIG. 5C, after voice validity determination processing, a first audio frame in the K audio frames is determined as an invalid audio frame, thereby obtaining that the J audio frames are valid audio frames.

Operation 3.2: Perform gain prediction by using the target amplitude in the obtained amplitude constraint parameter and a level description value of the j^{th} audio frame to obtain a predicted amplitude gain.

The predicted amplitude gain is a gain required for adjusting the level description value of the j^{th} audio frame to the target amplitude. In specific gain prediction processing, units of the target amplitude and the level description value of the j^{th} audio frame need to be unified to ensure the calculation effectiveness. If the unit of the target amplitude is dB, the unit of the level description value also needs to be dB; or if the unit of the target amplitude is an amplitude, the unit of the level description value also needs to be an amplitude. When the unit is dB, a difference between the target amplitude and the level description value of the j^{th} audio frame may be first calculated according to a conversion relationship between levels and amplitudes, and the predicted amplitude gain is then obtained according to the calculated difference. A specific expression may be as follows:

$${G}_{r} = power ( 10 , \frac{d b - s l m}{20} )$$

Gᵣ represents the predicted amplitude gain, db represents the target amplitude and a unit thereof is dB, slm represents the level description value of the j^{th} audio frame and may be a smoothing amplitude obtained through smoothing processing, and power (a, b) represents power calculation with a as a base and b as an exponent, where a more popular expression is

$$10 \frac{d b - s l m}{20} .$$

If the unit is an amplitude, the level description value of the j^{th} audio frame may be directly used as a denominator and the target amplitude is used as a numerator to calculate a ratio thereof, and the calculated ratio is used as the predicted amplitude gain. A specific expression is as follows:

$${G}_{r 1} = \frac{slm}{d b}$$

Gᵣ₁ represents the predicted amplitude gain, db represents the target amplitude and a unit thereof is an amplitude, and slm represents the level description value of the j^{th} audio frame.

Operation 3.3: Determine a smaller value of the amplitude gain threshold of the obtained amplitude constraint parameter and the predicted amplitude gain as a frame amplitude gain required for adjusting an amplitude of the j^{th} audio frame.

To avoid an abnormality caused by excessively large adjustment on the amplitude of the audio frame, the amplitude may be finally constrained through the amplitude gain threshold. If the calculated predicted amplitude gain is greater than the amplitude gain threshold, the amplitude gain threshold may be used as the frame amplitude gain required for adjusting the amplitude of the j^{th} audio frame. If the calculated predicted amplitude gain is less than the amplitude gain threshold, the calculated predicted amplitude gain may be used as the frame amplitude gain required for adjusting the amplitude of the j^{th} audio frame. Certainly, if the calculated predicted amplitude gain is equal to the amplitude gain threshold, any of the two values may be used as the frame amplitude gain required for adjusting the amplitude of the j^{th} audio frame. The frame amplitude gain mentioned above is an amplitude gain required for adjusting the amplitude of the audio frame for the audio frame. A specific calculation formula may be as follows:

$$g ( j ) = min ( G max , {G}_{r} )$$

g(i) represents the frame amplitude gain of the j^{th} audio frame, min( ) represents taking a minimum value in a plurality of parameters, Gmax represents the amplitude gain threshold, and Gᵣ represents the predicted amplitude gain.

For each audio frame in the J audio frames, a corresponding frame amplitude gain may be determined according to the foregoing manner, and frame amplitude gains of different audio frames may be the same or different. For example, both frame amplitude gains of a first audio frame and a second audio frame are the amplitude gain threshold. For another example, a frame amplitude gain of a first audio frame is the amplitude gain threshold, and a frame amplitude gain of a third audio frame is the predicted amplitude gain.

Operation 3.4: Continue traversal until the J audio frames are all traversed to obtain the amplitude gain corresponding to the current audio signal.

The computer device may continue to traverse a next audio frame of the current audio frame, use the next audio frame as a new current audio frame, and perform processing similar to operation 3.2 and operation 3.3 on the new current audio frame to obtain a frame amplitude gain of the audio frame. Through continuous traversal, the frame amplitude gains respectively corresponding to the audio frames on which signal level monitoring has been performed, and the amplitude gain of the current audio signal may be further obtained. That is, the amplitude gain of the current audio signal includes a frame amplitude gain corresponding to each audio frame in the J audio frames. For example, the current audio signal includes 100 frames, where signal level monitoring has been performed on 80 frames, and the amplitude gain of the current audio signal may include frame amplitude gains respectively corresponding to the 80 audio frames. The determined frame amplitude gains may be configured for adjusting amplitudes of the audio frames, to further realize volume adjustment on the current audio signal.

In the foregoing manner shown by operation 3.1 to operation 3.4, an initial amplitude gain may be first predicted according to the target amplitude and the level description value of the audio frame, and the predicted initial amplitude gain is constrained by using the amplitude gain threshold to implement control on the frame amplitude gain required by the audio frame, thereby ensuring subsequent proper adjustment on the amplitude of the audio frame.

(4) Perform gain processing on the amplitude of the current audio signal by using the amplitude gain of the current audio signal to adjust a volume of the current audio signal, to obtain a current audio signal after volume adjustment.

In an embodiment, the computer device may use the whole current audio signal as a unit, the amplitude gain of the current audio signal may include one amplitude gain, and gain processing may be performed on amplitudes of sampling points included in the current audio signal by using the amplitude gain of the current audio signal, to implement adjustment on the volume of the current audio signal, thereby obtaining the current audio signal after volume adjustment. In this manner, the current audio signal after volume adjustment includes sampling points and gained amplitudes of the sampling points. Adjustment on the amplitudes of the sampling points in the current audio signal is unified, so that the amplitude of the current audio signal can be quickly adjusted, thereby improving the volume adjustment efficiency.

In another embodiment, the current audio signal is framed into K (K is an integer greater than 1) audio frames, that is, the current audio signal may be framed into at least two audio frames; and the amplitude gain of the current audio signal includes frame amplitude gains of J audio frames on which signal level monitoring is performed in the K audio frames, where J≤K. When performing content shown by the foregoing (4), the computer device specifically may perform the following operation 4.1 to operation 4.5:

Operation 4.1: Traverse the J audio frames related to the level description value of the current audio signal to determine a currently traversed j^{th} audio frame, where j∈[1, J].

In a specific implementation, the J audio frames may be arranged according to a playing sequence. Therefore, the computer device may traverse the J audio frames according to the playing sequence of the audio frames in the audio signal, and the traversed j^{th} audio frame is an audio frame that needs to be currently processed. For example, traversal may be performed by using a first audio frame in the J audio frames as a traversal start point and in a direction in which arrangement positions of the audio frames are increased. The j^{th} audio frame has passed signal level monitoring and has a corresponding level description value, and required gain control is performed on the J audio frames according to content described in the foregoing (3) to obtain the corresponding frame amplitude gains.

In an implementation, each audio frame includes a plurality of sampling points and amplitudes of the sampling points, and the computer device may perform gain processing on the amplitude of each sampling point in the j^{th} audio frame by using the frame amplitude gain of the j^{th} audio frame, to obtain a gained amplitude of the j^{th} audio frame. Specifically, the frame amplitude gain of the j^{th} audio frame may be multiplied by the amplitude of each sampling point in the j^{th} audio frame, and an obtained result is the gained amplitude. A j^{th} audio frame after volume adjustment corresponding to the j^{th} audio frame is generated according to the sampling points and a gained amplitude of each sampling point. In this manner, amplitude adjustment is performed by using the audio frame as a unit to adjust the volume of the audio frame, compared with a manner of performing amplitude adjustment by using the whole current audio signal as a unit, this manner is a relatively precise volume adjustment manner, so that proper adjustment can be performed according to a feature of the audio frame, and the final obtained current audio signal after volume adjustment is relatively natural.

In another implementation, to avoid noise in a sound caused by a sudden change in an adjustment process of the audio signal, gain adjustment may be performed on the currently processed audio frame level by level at a smaller granularity, for example, a length of 1 ms, which is shown by the following operation 4.2 to operation 4.4.

Operation 4.2: Divide the j^{th} audio frame into N audio sub-blocks, and determine an amplitude of each audio sub-block in the N audio sub-blocks, where N is an integer greater than 1.

Specifically, division may be first performed on the j^{th} audio frame, to divide the j^{th} audio frame into audio sub-blocks (or may be referred to as sub-blocks or audio sub-frames) with a smaller frame length through division, and adjustment is performed level by level on the amplitude of the audio frame by using the audio sub-block as a unit, so that the volume change of the audio signal can be smoother. In an implementation, division may be performed on the j^{th} audio frame according to a preset sub-block frame length to obtain at least two audio sub-blocks, and a frame length of each audio sub-block is less than or equal to the preset sub-block frame length. For example, as shown in FIG. 5D, the frame length of the j^{th} audio frame is five milliseconds (ms), and the audio frame may be divided into five audio sub-blocks according to a length of 1 ms for each sub-block. In another implementation, division may be performed on the j^{th} audio frame according to a preset quantity to obtain the preset quantity of audio sub-blocks, and frame lengths of the audio sub-blocks may be the same. For example, the audio frame whose frame length is five milliseconds may be divided according to a preset quantity of five into five audio sub-blocks. The audio sub-block may be then used as a unit to gain an amplitude of the audio sub-block obtained through division. Specifically, amplitudes of sampling points of the audio sub-block are gained to implement volume adjustment on the j^{th} audio frame.

Operation 4.3: Perform gain processing on the amplitude of each audio sub-block in the N audio sub-blocks level by level according to the frame amplitude gain of the j^{th} audio frame to adjust a volume of each audio sub-block.

In a specific implementation, a block amplitude gain of each audio sub-block in the N audio sub-blocks may be determined according to the frame amplitude gain of the j^{th} audio frame, and the block amplitude gain of any audio sub-block is an amplitude gain (or may be referred to as a sub-block gain or a subgain) required for gaining the amplitude of the audio sub-block. Gain processing may be performed on the amplitude of each audio sub-block level by level according to the block amplitude gain of each audio sub-block, to adjust the volume of each audio sub-block. Gain processing is performed on the amplitude of each audio sub-block level by level, so that the gained amplitudes of the audio sub-blocks obtained by dividing the same audio frame are changed level by level, for example, increased or reduced level by level, and the volumes are adjusted level by level at a smaller granularity.

“The amplitude gain of the current audio signal”, “the frame amplitude gain of the audio frame”, and “the block amplitude gain of the audio sub-block” mentioned in this application are essentially a gain value required for amplitude adjustment, and for ease of distinguishing, different names are used for audio signals with different lengths. For a complete current audio signal, the gain value corresponds to an amplitude gain, for a relatively small audio frame, the corresponding amplitude gain is referred to as a frame amplitude gain, and for a smaller audio sub-block, the corresponding amplitude gain is referred to as a block amplitude gain.

In an embodiment, before performing operation 4.3, the computer device may further determine an arrangement position of the j^{th} audio frame in the J audio frames, and the arrangement position may be configured for indicating whether the j^{th} audio frame is the first audio frame in the J audio frames, that is, whether the j^{th} audio frame is arranged at a first position; or the arrangement position may alternatively be configured for indicating whether the i^{th} audio frame corresponding to the j^{th} audio frame is a first audio frame on which signal level monitoring is performed in the K audio frames. Based on different arrangement positions, the following two cases may exist: If the determined arrangement position is not the first position, the foregoing operation 4.3 is triggered to be performed. That is, if the j^{th} audio frame is not the first audio frame in the J audio frames, an operation of performing gain processing on the amplitude of each audio sub-block in the N audio sub-blocks level by level according to the frame amplitude gain of the j^{th} audio frame may be performed, to adjust the volume of the j^{th} audio frame level by level. If the determined arrangement position is the first position, gain processing is performed on the amplitude of each audio sub-block in the N audio sub-blocks respectively by using the frame amplitude gain of the j^{th} audio frame to adjust the volume of each audio sub-block. That is, if the j^{th} audio frame is the first audio frame in the J audio frames, the frame amplitude gain of the j^{th} audio frame may be used as the block amplitude gain of each audio sub-block, and gain processing is performed on the amplitude of each audio sub-block obtained by dividing the first audio frame in the J audio frames by using the block amplitude gain to implement volume adjustment on each audio sub-block, thereby implementing volume adjustment on the first audio frame in the J audio frames. In this manner, the amplitudes of the N audio sub-blocks are adjusted by using a unified block amplitude gain, so that the first audio frame can be quickly adjusted.

In an implementation, when implementing adjustment on the j^{th} audio frame according to operation 4.3, the computer device specifically may perform the following operation 4.3.1 and operation 4.3.2.

Operation 4.3.1: Determine a block amplitude gain of each audio sub-block according to the frame amplitude gain of the j^{th} audio frame and an arrangement position of each audio sub-block in the N audio sub-blocks in the N audio sub-blocks.

Block amplitude gains of different audio sub-blocks change level by level along with increases of arrangement positions of the corresponding audio sub-blocks in the N audio sub-blocks. The change level by level herein may refer to being increased or reduced level by level. For example, the j^{th} audio frame is divided into five audio sub-blocks, the frame amplitude gain of the j^{th} audio frame is 5, and the block amplitude gains of the audio sub-blocks are respectively 3.0, 3.4, 3.8, 4.2, 4.6, and 5. As can be seen, the block amplitude gains of the audio sub-blocks are increased level by level. Therefore, by applying the block amplitude gains on amplitude adjustment of the audio sub-blocks, level-by-level gain adjustment on the audio frame can be implemented through level-by-level gain adjustment by using the audio sub-block as a unit, so that volume adjustment on the audio frame becomes smoother.

In a feasible implementation, when the arrangement position of the j^{th} audio frame in the J audio frames is not the first position and the computer device performs the foregoing operation 4.3.1, this operation specifically may be implemented in the following manner:

\textcircled{1} Determine a frame amplitude gain of a (j−1)^{th} audio frame in the J audio frames, and use a difference between the frame amplitude gain of the j^{th} audio frame and the frame amplitude gain of the (j−1)^{th} audio frame as a frame amplitude gain difference of the j^{th} audio frame relative to the (j−1)^{th} audio frame. The (j−1)^{th} audio frame is a previous audio frame of the j^{th} audio frame in the J audio frames, and a difference between the frame amplitude gains of the two adjacent audio frames, that is, the frame amplitude gain difference may be denoted as g(j)-g(j−1), where g(j) is the frame amplitude gain of the j^{th} audio frame, and g(j−1) is the frame amplitude gain of the (j−1)^{th} audio frame. \textcircled{2} Determine, for an n^{th} audio sub-block in the N audio sub-blocks, a required block amplitude gain change value of the n^{th} audio sub-block relative to the (j−1)^{th} audio frame according to an arrangement position of the n^{th} audio sub-block in the N audio sub-blocks and the frame amplitude gain difference. Specifically, a ratio of the arrangement position n of the n^{th} audio sub-block to a total quantity N of the audio sub-blocks obtained through division may be determined, and a product of the calculated ratio n/N and the frame amplitude gain difference is further used as the required block amplitude gain change value of the n^{th} audio sub-block relative to the (j−1)^{th} audio frame. A specific expression may be as follows: n*(g(j)−g(j−1))/N. 3̅ Obtain a block amplitude gain of the n^{th} audio sub-block according to the block amplitude gain change value and the frame amplitude gain of the (j−1)^{th} audio frame.

For example, a complete expression corresponding to calculation of the block amplitude gain according to the foregoing manner may be as follows:

$$subgain ( n ) = n * \frac{g ( i ) - g ( i - 1 )}{N} + g ( i - 1 )$$

subgain(n) represents the block amplitude gain of the n^{th} audio sub-block, n represents a sub-block sequence number of the n^{th} audio sub-block and represents an arrangement position of the n^{th} audio sub-block in the N audio sub-blocks, N represents a total quantity of audio sub-blocks obtained by dividing the j^{th} audio frame, g(i) represents the frame amplitude gain of the j^{th} audio frame, and g(i−1) represents the frame amplitude gain of the (j−1)^{th} audio frame.

Based on the foregoing expression, a block amplitude gain of a last audio sub-block in audio sub-blocks obtained by dividing the (j−1)^{th} audio frame is the same as the frame amplitude gain of the (j−1)^{th} audio frame, so that transition between amplitude adjustment on adjacent audio sub-blocks corresponding to different audio frames is relatively smooth rather than sudden. For each audio sub-block that is not located at a first position in the N audio sub-blocks, a corresponding block amplitude gain may be obtained according to the foregoing manner, and level-by-level gain adjustment on the audio frame is implemented by using the block amplitude gain.

When determining the n^{th} audio sub-block, the computer device may traverse the N audio sub-blocks sequentially, determine a currently traversed audio sub-block as the n^{th} audio sub-block, where n∈[1, N], and calculate the block amplitude gains of the N audio sub-blocks sequentially. Alternatively, the computer device may calculate the block amplitude gains of the N audio sub-blocks in parallel, to calculate the block amplitude gains for the audio sub-blocks in parallel according to the manner described above, so that the block amplitude gains of the N audio sub-blocks are quickly determined.

According to the foregoing manner, the block amplitude gain of the audio sub-block may be calculated based on the frame amplitude gain of the currently processed audio frame and the frame amplitude gain of the previous audio frame, and the obtained block amplitude gain can change level by level along with an increase of the arrangement position of each audio sub-block. The audio sub-block is adjusted through level-by-level change of the block amplitude gain, so that amplitudes in one audio frame also change level by level by using the audio sub-block as a unit. Therefore, amplitude adjustment within one frame may be stable, and based on cohesion of amplitude gains between adjacent audio frames, an amplitude change between adjacent audio frames is also stable.

In a specific implementation, the block amplitude gain of the last audio sub-block in the audio sub-blocks obtained by dividing the (j−1)^{th} audio frame is also configured for a determination process of the block amplitude gains of the audio sub-blocks in the j^{th} audio frame, to implement level-by-level change of the block amplitude gains. In a specific implementation, the frame amplitude gain of the (j−1)^{th} audio frame mentioned above may be replaced with the block amplitude gain of the last audio sub-block in the audio sub-blocks obtained by dividing the (j−1)^{th} audio frame. For the n^{th} audio sub-block, the corresponding frame amplitude gain difference and the corresponding block amplitude gain change value are sequentially obtained, and a sum of the block amplitude gain change value and the block amplitude gain of the last audio sub-block obtained by dividing the (j−1)^{th} audio frame is used as the block amplitude gain of the n^{th} audio sub-block.

In another embodiment, the foregoing operation 4.3 can be triggered to be performed no matter whether the arrangement position of the j^{th} audio frame in the J audio frames is the first position. To gain the amplitudes of the audio sub-blocks in the audio frame level by level, for an audio frame whose arrangement position is the first position in the J audio frames, that is, when the arrangement position of the j^{th} audio frame in the J audio frames is the first position, the block amplitude gain of each audio sub-block may be determined according to the arrangement position of the audio sub-block in the N audio sub-blocks and the frame amplitude gain of the j^{th} audio frame. In this way, the block amplitude gain of the audio sub-block is determined by the arrangement position of the audio sub-block, different audio sub-blocks have different block amplitude gains, and the block amplitude gains of the N audio sub-blocks change level by level along with increases of the arrangement positions of the audio sub-blocks, so that amplitude adjustment is performed on each audio sub-block in the N audio sub-blocks level by level according to the block amplitude gain of the audio sub-block. Specifically, for the n^{th} (n∈[1, N]) audio sub-block in the N audio sub-blocks, the ratio of the arrangement position n of the n^{th} audio sub-block in the N audio sub-blocks to the total quantity N of the audio sub-blocks obtained by dividing the j^{th} audio frame may be calculated, the ratio is then multiplied by the frame amplitude gain of the j^{th} audio frame, and an obtained product result is the block amplitude gain of the n^{th} audio sub-block. For example, an expression of the foregoing calculation may be as follows:

$$subgain ( n ) = n * \frac{g ( 1 )}{N}$$

subgain(n) represents the block amplitude gain of the n^{th} audio sub-block, n represents a sub-block sequence number of the n^{th} audio sub-block and may represent the arrangement position of the audio sub-block in the N audio sub-blocks, N represents the total quantity of the audio sub-blocks obtained by dividing the j^{th} audio frame, and g(1) represents a frame amplitude gain of a first audio frame in the J audio frames.

The block amplitude gain of the last audio sub-block in the N audio sub-blocks that is calculated in the foregoing manner is the frame amplitude gain of the j^{th} audio frame. In addition, the block amplitude gains of different audio sub-blocks determined in the foregoing manner are increased level by level along with an increase of the arrangement position n of the audio sub-block in the N audio sub-blocks, so that the amplitude of the j^{th} audio frame is adjusted level by level by using the audio sub-block as a unit.

Operation 4.3.2: Perform gain processing on an amplitude of a corresponding audio sub-block by using the block amplitude gain of each audio sub-block.

Gain processing is performed on the amplitude of the corresponding audio sub-block by using the block amplitude gain of each audio sub-block, so that each audio sub-block after volume adjustment may be obtained. Using the n^{th} audio sub-block as an example, the n^{th} audio sub-block includes a plurality of sampling points and amplitudes of the sampling points, and the computer device may perform gain processing on the amplitude of the n^{th} audio sub-block by using the determined block amplitude gain to obtain a gained amplitude corresponding to the n^{th} audio sub-block. Specifically, the amplitudes of the sampling points are multiplied by the block amplitude gain of the n^{th} audio sub-block, and obtained products are gained amplitudes of the corresponding sampling points. That is, the gained amplitude corresponding to the n^{th} audio sub-block includes the gained amplitudes of the sampling points, and an n^{th} audio sub-block after volume adjustment may be obtained by integrating the gained amplitudes of the sampling points and the sampling points. Gain processing may be performed for each audio sub-block in the N audio sub-blocks according to the foregoing manner to obtain each audio sub-block after volume adjustment, and a volume of each audio sub-block after volume adjustment also change level by level along with an increase of the arrangement position of the corresponding audio sub-block in the N audio sub-blocks.

In the volume adjustment manner for an audio frame shown in the foregoing operation 4.3.1 and operation 4.3.2, the amplitude of each audio sub-block in one audio frame is adjusted level by level by using the audio sub-block as a unit and using the block amplitude gain of the audio sub-block, so that volume adjustment of the audio frame is stably transitioned.

Operation 4.4: After obtaining each audio sub-block after volume adjustment, obtain a j^{th} audio frame after volume adjustment through splicing by using each audio sub-block after volume adjustment.

Any audio sub-block after volume adjustment is a new audio sub-block obtained by implementing volume adjustment by using an amplitude gain. The computer device may splice each audio sub-block after volume adjustment according to the arrangement position, to obtain the j^{th} audio frame after volume adjustment.

Operation 4.5: Continue traversal until the J audio frames are all traversed to obtain J audio frames after volume adjustment, and splice the J audio frames after volume adjustment to obtain the current audio signal after volume adjustment.

After the j^{th} audio frame is processed, the computer device may continue to traverse a next audio frame to perform level-by-level gaining by using similar logic to obtain an audio frame after volume adjustment until the J audio frames are all traversed. In this way, audio frames after volume adjustment that respectively correspond to the audio frames on which signal level monitoring has been performed may be obtained, and the audio frames after volume adjustment may be spliced according to the arrangement positions to obtain the current audio signal after volume adjustment.

In a specific implementation, the audio frames after volume adjustment may be directly spliced according to the arrangement positions to obtain the current audio signal after volume adjustment. In another specific implementation, if L is less than K, that is, a quantity of audio frames on which signal level monitoring is performed in the K audio frames is less than K, it indicates that some invalid audio frames on which signal level monitoring is not performed exist in the K audio frames, and the computer device may splice the audio frames after volume adjustment and audio frames other than the J audio frames in the K audio frames to obtain the current audio signal after volume adjustment.

For the current audio signal, using each audio frame obtained through division as a processing object, for the audio sub-blocks obtained through division in each audio frame on which signal level monitoring is performed, the amplitude of the audio frame can be adjusted level by level according to the manner shown by the foregoing operation 4.1 to operation 4.5. In a specific implementation, a suitable block amplitude gain may be determined for each audio sub-block in the N audio sub-blocks based on the frame amplitude gain of the j^{th} audio frame, and gain processing is further performed on the corresponding audio sub-block based on the block amplitude gain. Therefore, each audio sub-block in the audio frame is gained level by level by using the block amplitude gain, to implement stable adjustment on the volume of the audio frame, so that a volume change corresponding to the audio signal after volume adjustment is relatively smooth.

The volume adjustment manner shown by (1) to (4) is applicable to the real audio signal or the virtual audio signal. In addition, in a specific processing process, the level of the processed current audio signal may be monitored, and gain control processing may be performed based on the amplitude constraint parameter of the current audio signal in the target sound mixing mode and the monitored level description value, to determine a suitable amplitude gain for adjusting the amplitude of the current audio signal, thereby finally obtaining the current audio signal after volume adjustment through amplitude adjustment. In this process, amplitude adjustment on the current audio signal is constrained by using the amplitude constraint parameter with an objective of realizing the sound mixing effect required by the target sound mixing mode, so that amplitude adjustment becomes more proper, and a relatively good audio signal after volume adjustment configured for sound mixing is obtained, which is conducive to realizing a relatively good sound mixing effect.

Based on the foregoing description, a schematic flowchart of volume adjustment shown by FIG. 6A may be provided. As shown in FIG. 6A, a real world stereo may be acquired in real time by using a stereo recording headset to obtain a sound signal. An example in which the inputted sound signal is an acquired real world sound signal is used, the sound signal may be converted into a real audio signal, voice validity determination processing (for example, VAD determination) is then performed by using an audio frame as a unit, signal level monitoring is then performed on a valid audio frame by using the audio frame as a minimum unit, after a level description value is obtained through monitoring, gain control may be performed on the valid audio frame based on a target amplitude and an amplitude gain threshold that correspond to setting of the target sound mixing mode, to determine an amplitude gain required for amplitude adjustment performed on the valid audio frame through gain control, and adjustment is finally performed on a sampling point amplitude of the valid audio frame to obtain an audio frame after volume adjustment. According to the foregoing procedure, adjustment may be performed on each valid audio frame to implement volume adjustment, and a final real audio signal after volume adjustment is obtained.

S404: Mix the real audio signal after volume adjustment and the virtual audio signal after volume adjustment to obtain the sound-mixed signal.

In a specific implementation, a sound mixing algorithm such as an average weight method or a self-adaptive weight method may be used to mix the real audio signal after volume adjustment and the virtual audio signal after volume adjustment to obtain and output the sound-mixed signal, where the sound-mixed signal is a result obtained by integrating the real world sound the virtual world sound. In this way, audio processing in the augmented reality scene is completed, and enhancement processing on the real world sound and the virtual world sound is also implemented.

In an implementation, each sound mixing mode corresponds to a weight parameter group, and the weight parameter group includes a first weight for the real audio signal in a corresponding sound mixing mode and a second weight for the virtual audio signal in the corresponding sound mixing mode. Different sound mixing modes correspond to different weight parameter groups, which specifically represents that the real world sound and the virtual world sound can be mixed by using different weights. With the help of the weight parameter group, a sound mixing effect realized in the corresponding sound mixing mode can be further enhanced. For example, in the equivalent sound mixing mode, the first weight and the second weight in the weight parameter group corresponding to the equivalent sound mixing mode may be the same; and in the strong real sound mixing mode, the first weight is greater than the second weight in the weight parameter group corresponding to the strong real sound mixing mode, to further enhance a volume of the real audio signal, so that the real world sound is more likely to be heard.

The computer device may obtain a weight parameter group corresponding to the target sound mixing mode and use the weight parameter group as a target weight parameter group, where the target weight parameter group includes a first weight for the real audio signal in the target sound mixing mode and a second weight for the virtual audio signal in the target sound mixing mode. The computer device then may use the first weight and the second weight in the target weight parameter group to perform weighting processing on the real audio signal after volume adjustment and the virtual audio signal after volume adjustment to obtain the sound-mixed signal. In a specific implementation, summation may be performed on a product of the first weight and the real audio signal after volume adjustment and a product of the second weight and the virtual audio signal after volume adjustment, and an obtained weighted summation result may be used as the sound-mixed signal.

In the embodiments of this application, after the target sound mixing mode is determined for the real audio signal and the virtual audio signal in the augmented reality scene, volume adjustment processing may be performed on the real audio signal and the virtual audio signal according to the target sound mixing mode to reach volume values required by the sound mixing effect through volume adjustment, and sound mixing then may be performed on the real audio signal after volume adjustment and the virtual audio signal after volume adjustment to obtain and output the sound-mixed signal. In the whole process, a user may autonomously set the target sound mixing mode or the computer device automatically determines the target sound mixing mode, and controls volume adjustment on the audio signal according to the target sound mixing mode, so that a relatively good sound mixing effect can be reached between the real world sound and the virtual world sound after sound mixing through volume adjustment, thereby bringing corresponding auditory perception experience.

According to the foregoing content shown by S401 to S404, a schematic flowchart shown by FIG. 6B may be further provided. As shown in FIG. 6B, a stereo recording signal may be obtained, where the stereo recording signal is obtained by acquiring a real world sound in real time by using a stereo recording headset; environmental noise interference may be then filtered out through noise reduction processing to obtain a denoised real audio signal, where the denoised real audio signal may participate in subsequent related processing with a virtual world sound source; adjustment may be performed on a volume of a real sound source and a volume of a virtual sound source according to the volume adjustment procedure shown in FIG. 6A, and specifically, adjustment may be performed on volumes of audio signals corresponding to sounds generated by the sound sources based on a configured target sound mixing mode; and finally, sound mixing is performed on a real audio signal after volume adjustment and a virtual audio signal after volume adjustment to realize sound mixing of a real world stereo and a virtual world stereo. This solution mainly focuses on integration of a real world sound and a virtual world sound in the auditory aspect, and specifically is a solution of integrating an audio signal from a real world and an audio signal from a virtual world. In this solution, an external real world sound may be acquired by using a stereo recording headset, the sound is to become a directional sound source for subsequent processing with a virtual space sound source, the user may set different sound mixing modes to control a mixing manner of the real world sound source, and the real world sound and the virtual world sound are enhanced and then outputted mixedly as a stereo. For example, after the real world sound is acquired through a stereo microphone by using an AR headset, the real world sound may be used as a sound generated by an independent stereo sound source for stereo sound mixing with a sound generated by a sound source constructed in a virtual world, and the user may customize the sound mixing mode to realize different sound mixing effects between the real world sound source and the virtual world sound source, which can resolve the existing problem that there is only integration in the visual aspect and there is no deep integration in the audio aspect in the AR scene.

The following describes an audio processing apparatus related to the embodiments of this application.

Referring to FIG. 7, FIG. 7 is a schematic structural diagram of an audio processing apparatus according to an embodiment of this application. The audio processing apparatus may be arranged in a computer device provided in the embodiments of this application. For example, the computer device may be the computer device mentioned in the foregoing method embodiments. The audio processing apparatus shown in FIG. 7 may be a computer program (including program code) running in the computer device. The audio processing apparatus may be configured to implement some or all of the operations in the method embodiments shown in FIG. 2 and FIG. 4. The audio processing apparatus may include the following units:
an obtaining unit 701, configured to obtain a real audio signal and a virtual audio signal in an augmented reality scene, where the real audio signal is an audio signal acquired in a real environment on which the augmented reality scene is based, and the virtual audio signal is an audio signal constructed in a virtual environment on which the augmented reality scene is based;
a processing unit 702, configured to: determine a plurality of sound mixing modes configured for the augmented reality scene, and select one sound mixing mode from the plurality of sound mixing modes as a target sound mixing mode, where different sound mixing modes are configured for realizing different sound mixing effects between the real audio signal and the virtual audio signal;
the processing unit 702 being further configured to perform sound mixing processing on the real audio signal and the virtual audio signal according to the target sound mixing mode to obtain a sound-mixed signal; and an output unit 703, configured to output the sound-mixed signal.
In an embodiment, when selecting one sound mixing mode from the plurality of sound mixing modes as the target sound mixing mode, the processing unit 702 is specifically configured to:
obtain a mode configuration operation, and select one sound mixing mode from the plurality of sound mixing modes as the target sound mixing mode according to the mode configuration operation, where
the mode configuration operation includes: a select operation for a plurality of mode identifiers displayed in an augmented reality application, where one mode identifier corresponds to one sound mixing mode; or the mode configuration operation includes: a mode select operation performed by operating a physical key on an augmented reality device.

In an embodiment, when selecting one sound mixing mode from the plurality of sound mixing modes as the target sound mixing mode, the processing unit 702 is specifically configured to:
determine geographical position information of the real environment on which the augmented reality scene is based, and determine an environment type of the real environment according to the geographical position information; and
select one sound mixing mode from the plurality of sound mixing modes as the target sound mixing mode according to a requirement of the determined environment type for sound integration.

In an embodiment, when performing sound mixing processing on the real the sound-mixed signal, the processing unit 702 is specifically configured to:
perform volume adjustment on the real audio signal and the virtual audio signal respectively according to the target sound mixing mode, to obtain a real audio signal after volume adjustment and a virtual audio signal after volume adjustment; and
mix the real audio signal after volume adjustment and the virtual audio signal after volume adjustment to obtain the sound-mixed signal.

In an embodiment, a volume of an audio signal changes along with an amplitude change of the audio signal; and when performing volume adjustment on the real audio signal and the virtual audio signal respectively according to the target sound mixing mode to obtain the real audio signal after volume adjustment and the virtual audio signal after volume adjustment, the processing unit 702 is specifically configured to:
traverse the real audio signal and the virtual audio signal, use a currently traversed audio signal as a current audio signal, and obtain an amplitude constraint parameter of the current audio signal in the target sound mixing mode;
perform signal level monitoring on the current audio signal to obtain a level description value of the current audio signal, where the level description value of the current audio signal is configured for indicating an amplitude of the current audio signal;
control, according to the obtained amplitude constraint parameter and the level description value of the current audio signal, a gain required by the amplitude of the current audio signal, to obtain an amplitude gain of the current audio signal; and
perform gain processing on the amplitude of the current audio signal by using the amplitude gain of the current audio signal to adjust a volume of the current audio signal, to obtain a current audio signal after volume adjustment.

In an embodiment, when obtaining the amplitude constraint parameter of the current audio signal in the target sound mixing mode, the processing unit 702 is specifically configured to:
obtain a preset mapping table, where the preset mapping table includes a plurality of mode identifiers and a parameter group mapped from each mode identifier; and the parameter group mapped from any mode identifier includes: a first amplitude constraint parameter of the virtual audio signal in a sound mixing mode identified by a corresponding mode identifier and a second amplitude constraint parameter of the real audio signal in the sound mixing mode identified by the corresponding mode identifier;
query the preset mapping table according to a mode identifier of the target sound mixing mode, to obtain a parameter group mapped from the mode identifier of the target sound mixing mode;
if the current audio signal is the virtual audio signal, select the first amplitude constraint parameter from the obtained parameter group as the amplitude constraint parameter of the current audio signal in the target sound mixing mode; or
if the current audio signal is the real audio signal, select the second amplitude constraint parameter from the obtained parameter group as the amplitude constraint parameter of the current audio signal in the target sound mixing mode.

In an embodiment, the plurality of sound mixing modes include at least two of the following: a strong real sound mixing mode, a strong virtual sound mixing mode, an equivalent sound mixing mode, a real-closed sound mixing mode, and a virtual-closed sound mixing mode; the amplitude constraint parameter of any audio signal is positively correlated with a volume of a corresponding audio signal after volume adjustment;
in the strong real sound mixing mode, the amplitude constraint parameter of the real audio signal and the amplitude constraint parameter of the virtual audio signal are both valid values, and the amplitude constraint parameter of the real audio signal is greater than the amplitude constraint parameter of the virtual audio signal;
in the strong virtual sound mixing mode, the amplitude constraint parameter of the real audio signal and the amplitude constraint parameter of the virtual audio signal are both valid values, and the amplitude constraint parameter of the virtual audio signal is greater than the amplitude constraint parameter of the real audio signal;
in the equivalent sound mixing mode, the amplitude constraint parameter of the real audio signal and the amplitude constraint parameter of the virtual audio signal are both valid values, and the amplitude constraint parameter of the virtual audio signal is equal to the amplitude constraint parameter of the real audio signal;
in the real-closed sound mixing mode, the amplitude constraint parameter of the real audio signal is an invalid value, and the amplitude constraint parameter of the virtual audio signal is a valid value; and
in the virtual-closed sound mixing mode, the amplitude constraint parameter of the real audio signal is a valid value, and the amplitude constraint parameter of the virtual audio signal is an invalid value.

In an embodiment, when performing signal level monitoring on the current audio signal to obtain the level description value of the current audio signal, the processing unit 702 is specifically configured to:
perform framing processing on the current audio signal to obtain K audio frames of the current audio signal, where K is an integer greater than 1;
traverse the K audio frames, and determine a currently traversed i^{th} audio frame, where i∈[1, K];
perform signal level monitoring on the i^{th} audio frame to obtain a level description value of the i^{th} audio frame; or perform voice validity determination processing on the i^{th} audio frame, and perform signal level monitoring on the i^{th} audio frame in a case of determining that the i^{th} audio frame is a valid audio frame, to obtain a level description value of the i^{th} audio frame; and
continue traversal until the K audio frames are all traversed to obtain the level description value of the current audio signal, where the level description value of the current audio signal includes level description values of the audio frames obtained through monitoring.

In an embodiment, each audio frame includes a plurality of sampling points and amplitudes of the sampling points; and when performing signal level monitoring on the i^{th} audio frame to obtain the level description value of the i^{th} audio frame, the processing unit 702 is specifically configured to:
perform mean calculation on the amplitudes of the sampling points in the i^{th} audio frame to obtain a signal amplitude mean of the i^{th} audio frame; and
perform smoothing processing on the signal amplitude mean of the i^{th} audio frame to obtain the level description value of the i^{th} audio frame.

In an embodiment, when performing smoothing processing on the signal amplitude mean of the i^{th} audio frame to obtain the level description value of the i^{th} audio frame, the processing unit 702 is specifically configured to:
search the K audio frames for a reference audio frame of the i^{th} audio frame, where if voice validity determination processing is not performed on the i^{th} audio frame, the reference audio frame includes an (i−1)^{th} audio frame; or if voice validity determination processing is performed on the i^{th} audio frame, the reference audio frame includes a valid audio frame that is located before the i^{th} audio frame and closest to the i^{th} audio frame;
if the reference audio frame is not found, use the signal amplitude mean of the i^{th} audio frame as the level description value of the i^{th} audio frame; or
if the reference audio frame is found, perform smoothing processing on the signal amplitude mean of the i^{th} audio frame by using a level description value of the reference audio frame, to obtain the level description value of the i^{th} audio frame.

In an embodiment, the current audio signal is framed into K audio frames; the level description value of the current audio signal includes level description values of J audio frames on which signal level monitoring is performed in the K audio frames, where K is an integer greater than 1 and J≤K; the obtained amplitude constraint parameter includes a target amplitude and an amplitude gain threshold; and
when controlling, according to the obtained amplitude constraint parameter and the level description value of the current audio signal, the gain required by the amplitude of the current audio signal, to obtain the amplitude gain of the current audio signal, the processing unit 702 is specifically configured to:
traverse the J audio frames related to the level description value of the current audio signal to determine a currently traversed j^{th} audio frame, where j∈[1, J];
perform gain prediction by using the target amplitude in the obtained amplitude constraint parameter and a level description value of the j^{th} audio frame to obtain a predicted amplitude gain, where the predicted amplitude gain is a gain required for adjusting the level description value of the j^{th} audio frame to the target amplitude;
determine a smaller value of the amplitude gain threshold of the obtained amplitude constraint parameter and the predicted amplitude gain as a frame amplitude gain required for adjusting an amplitude of the j^{th} audio frame; and
continue traversal until the J audio frames are all traversed to obtain the amplitude gain of the current audio signal, where the amplitude gain of the current audio signal includes a frame amplitude gain corresponding to each audio frame in the J audio frames.

In an embodiment, the current audio signal is framed into K audio frames, and the amplitude gain of the current audio signal includes frame amplitude gains of J audio frames on which signal level monitoring is performed in the K audio frames, where K is an integer greater than 1 and J≤K; and
when performing gain processing on the amplitude of the current audio signal by using the amplitude gain of the current audio signal to adjust the volume of the current audio signal, to obtain the current audio signal after volume adjustment, the processing unit 702 is specifically configured to:
traverse the J audio frames related to the level description value of the current audio signal to determine a currently traversed j^{th} audio frame, where j∈[1, J];
divide the j^{th} audio frame into N audio sub-blocks, and determine an amplitude of each audio sub-block in the N audio sub-blocks, where N is an integer greater than 1;
perform gain processing on the amplitude of each audio sub-block in the N audio sub-blocks level by level according to the frame amplitude gain of the j^{th} audio frame to adjust a volume of each audio sub-block;
after obtaining each audio sub-block after volume adjustment, obtain a j^{th} audio frame after volume adjustment through splicing by using each audio sub-block after volume adjustment; and
continue traversal until the J audio frames are all traversed to obtain J audio frames after volume adjustment, and splice the J audio frames after volume adjustment to obtain the current audio signal after volume adjustment.

In an embodiment, the processing unit 702 is further configured to:
determine an arrangement position of the j^{th} audio frame in the J audio frames;
if the determined arrangement position is not a first position, trigger to perform the operation of performing gain processing on the amplitude of each audio sub-block in the N audio sub-blocks level by level according to the frame amplitude gain of the j^{th} audio frame to adjust a volume of each audio sub-block; or
if the determined arrangement position is a first position, perform gain processing on the amplitude of each audio sub-block in the N audio sub-blocks respectively by using the frame amplitude gain of the j^{th} audio frame to adjust the volume of each audio sub-block.

In an embodiment, when performing gain processing on the amplitude of each audio sub-block in the N audio sub-blocks level by level according to the frame amplitude gain of the j^{th} audio frame, the processing unit 702 is specifically configured to:
determine a block amplitude gain of each audio sub-block according to the frame amplitude gain of the j^{th} audio frame and an arrangement position of each audio sub-block in the N audio sub-blocks in the N audio sub-blocks, where block amplitude gains of different audio sub-blocks change level by level along with increases of arrangement positions of the corresponding audio sub-blocks in the N audio sub-blocks; and
perform gain processing on an amplitude of a corresponding audio sub-block by using the block amplitude gain of each audio sub-block.

In an embodiment, the arrangement position of the j^{th} audio frame in the J audio frames is not a first position; and
when determining the block amplitude gain of each audio sub-block according to the frame amplitude gain of the j^{th} audio frame and the arrangement position of each audio sub-block in the N audio sub-blocks in the N audio sub-blocks, the processing unit 702 is specifically configured to:
determine a frame amplitude gain of a (j−1)^{th} audio frame in the J audio frames, and use a difference between the frame amplitude gain of the j^{th} audio frame and the frame amplitude gain of the (j−1)^{th} audio frame as a frame amplitude gain difference of the j^{th} audio frame relative to the (j−1)^{th} audio frame;
determine, for an n^{th} audio sub-block in the N audio sub-blocks, a required block amplitude gain change value of the n^{th} audio sub-block relative to the (j−1)^{th} audio frame according to an arrangement position of the n^{th} audio sub-block in the N audio sub-blocks and the frame amplitude gain difference, where n∈[1, N]; and
obtain a block amplitude gain of the n^{th} audio sub-block according to the block amplitude gain change value and the frame amplitude gain of the (j−1)^{th} audio frame.

In an embodiment, before performing sound mixing processing on the real the sound-mixed signal, the processing unit 702 is further configured to:
determine a scene type of the augmented reality scene, and perform sound effect processing on the real audio signal and the virtual audio signal in the augmented reality scene respectively according to a requirement of the scene type for a sound effect; or
obtain the environment type of the real environment on which the augmented reality scene is based, and perform sound effect processing on the real audio signal and the virtual audio signal in the augmented reality scene respectively according to a requirement of the environment type of the real environment for a sound effect, where
the sound effect processing includes at least one of the following: reverberation processing and balancing processing.

In an embodiment, each sound mixing mode in the plurality of sound mixing modes has a mode identifier, each mode identifier corresponds to one balancing parameter group required for performing balancing processing, and the balancing parameter group corresponding to any mode identifier includes: a first volume balancing parameter of the virtual audio signal in a corresponding sound mixing mode and a second volume balancing parameter of the real audio signal in the corresponding sound mixing mode; and before performing sound mixing processing on the real audio signal and the virtual audio signal according to the target sound mixing mode to obtain the sound-mixed signal, the processing unit 702 is further configured to:
obtain a balancing parameter group corresponding to the mode identifier of the target sound mixing mode; and
perform balancing processing on the virtual audio signal by using the first volume balancing parameter in the obtained balancing parameter group, and perform balancing processing on the real audio signal by using the second volume balancing parameter in the obtained balancing parameter group.

In this embodiment of this application, a real audio signal and a virtual audio signal in an augmented reality scene may be obtained. A plurality of sound mixing modes configured for the augmented reality scene are determined, and one sound mixing mode is selected from the plurality of sound mixing modes as a target sound mixing mode, where different sound mixing modes may be configured for realizing different sound mixing effects between the real audio signal and the virtual audio signal, thereby bringing different auditory experiences. By determining the plurality of sound mixing modes for the augmented reality scene, diversified selections can be provided for setting of the target sound mixing mode, and the target sound mixing mode can be flexibly set, so that various scenes in which the real audio signal and the virtual audio signal need to be mixed can be adapted to, and some personalized sound mixing requirements of the user can also be met. Sound mixing processing is performed on the real audio signal and the virtual audio signal according to the target sound mixing mode to obtain a sound-mixed signal, and the sound-mixed signal is outputted. Since the target sound mixing mode can realize a corresponding sound mixing effect between the real audio signal and the virtual audio signal, by controlling sound mixing processing on the real audio signal and the virtual audio signal in the target sound mixing mode, integration of sounds in the real world and sounds in the virtual world on which the augmented reality scene is based may be realized in an auditory dimension, so that sound integration in the augmented reality scene is increased in the auditory aspect, an integration capability in the augmented reality scene is enriched, and the obtained sound-mixed signal also has the sound mixing effect corresponding to the target sound mixing mode. The sound-mixed signal is finally outputted, so that the user can feel a sound integration effect in the augmented reality scene more intuitively, thereby improving an immersed sense of the user in the augmented reality scene.

The following describes a computer device according to the embodiments of this application.

An embodiment of this application further provides a schematic structural diagram of a computer device. For the schematic structural diagram of the computer device, reference may be made to FIG. 8. The computer device may include: a processor 801, an input device 802, an output device 803, and a memory 804. The processor 801, the input device 802, the output device 803, and the memory 804 are connected by a bus. The memory 804 is configured to store a computer program, the computer program includes program instructions, and the processor 801 is configured to execute the program instructions stored in the memory 804.

In an embodiment, the computer device may be the terminal device in the system shown in FIG. 1A or the server in the system shown in FIG. 1B. In this embodiment, the processor 801 performs the following operations by executing executable program code in the memory 804:
obtaining a real audio signal and a virtual audio signal in an augmented reality scene, where the real audio signal is an audio signal acquired in a real environment on which the augmented reality scene is based, and the virtual audio signal is an audio signal constructed in a virtual environment on which the augmented reality scene is based;
determining a plurality of sound mixing modes configured for the augmented reality scene, and selecting one sound mixing mode from the plurality of sound mixing modes as a target sound mixing mode, where different sound mixing modes are configured for realizing different sound mixing effects between the real audio signal and the virtual audio signal;
performing sound mixing processing on the real audio signal and the virtual audio signal according to the target sound mixing mode to obtain a sound-mixed signal; and outputting the sound-mixed signal.

In an embodiment, when selecting one sound mixing mode from the plurality of sound mixing modes as the target sound mixing mode, the processor 801 is specifically configured to:
obtain a mode configuration operation, and select one sound mixing mode from the plurality of sound mixing modes as the target sound mixing mode according to the mode configuration operation, where
the mode configuration operation includes: a select operation for a plurality of mode identifiers displayed in an augmented reality application, where one mode identifier corresponds to one sound mixing mode; or the mode configuration operation includes: a mode select operation performed by operating a physical key on an augmented reality device.

In an embodiment, when selecting one sound mixing mode from the plurality of sound mixing modes as the target sound mixing mode, the processor 801 is specifically configured to:
determine geographical position information of the real environment on which the augmented reality scene is based, and determine an environment type of the real environment according to the geographical position information; and
select one sound mixing mode from the plurality of sound mixing modes as the target sound mixing mode according to a requirement of the determined environment type for sound integration.

In an embodiment, when performing sound mixing processing on the real the sound-mixed signal, the processor 801 is specifically configured to:
perform volume adjustment on the real audio signal and the virtual audio signal respectively according to the target sound mixing mode, to obtain a real audio signal after volume adjustment and a virtual audio signal after volume adjustment; and
mix the real audio signal after volume adjustment and the virtual audio signal after volume adjustment to obtain the sound-mixed signal.

In an embodiment, a volume of an audio signal changes along with an amplitude change of the audio signal; and when performing volume adjustment on the real audio signal and the virtual audio signal respectively according to the target sound mixing mode, to obtain the real audio signal after volume adjustment and the virtual audio signal after volume adjustment, the processor 801 is specifically configured to:
traverse the real audio signal and the virtual audio signal, use a currently traversed audio signal as a current audio signal, and obtain an amplitude constraint parameter of the current audio signal in the target sound mixing mode;
perform signal level monitoring on the current audio signal to obtain a level description value of the current audio signal, where the level description value of the current audio signal is configured for indicating an amplitude of the current audio signal;
control, according to the obtained amplitude constraint parameter and the level description value of the current audio signal, a gain required by the amplitude of the current audio signal, to obtain an amplitude gain of the current audio signal; and
perform gain processing on the amplitude of the current audio signal by using the amplitude gain of the current audio signal to adjust a volume of the current audio signal, to obtain a current audio signal after volume adjustment.

In an embodiment, when obtaining the amplitude constraint parameter of the current audio signal in the target sound mixing mode, the processor 801 is specifically configured to:
obtain a preset mapping table, where the preset mapping table includes a plurality of mode identifiers and a parameter group mapped from each mode identifier; and the parameter group mapped from any mode identifier includes: a first amplitude constraint parameter of the virtual audio signal in a sound mixing mode identified by a corresponding mode identifier and a second amplitude constraint parameter of the real audio signal in the sound mixing mode identified by the corresponding mode identifier;
query the preset mapping table according to a mode identifier of the target sound mixing mode, to obtain a parameter group mapped from the mode identifier of the target sound mixing mode;
if the current audio signal is the virtual audio signal, select the first amplitude constraint parameter from the obtained parameter group as the amplitude constraint parameter of the current audio signal in the target sound mixing mode; or
if the current audio signal is the real audio signal, select the second amplitude constraint parameter from the obtained parameter group as the amplitude constraint parameter of the current audio signal in the target sound mixing mode.

In an embodiment, the plurality of sound mixing modes include at least two of the following: a strong real sound mixing mode, a strong virtual sound mixing mode, an equivalent sound mixing mode, a real-closed sound mixing mode, and a virtual-closed sound mixing mode; the amplitude constraint parameter of any audio signal is positively correlated with a volume of a corresponding audio signal after volume adjustment;
in the strong real sound mixing mode, the amplitude constraint parameter of the real audio signal and the amplitude constraint parameter of the virtual audio signal are both valid values, and the amplitude constraint parameter of the real audio signal is greater than the amplitude constraint parameter of the virtual audio signal;
in the strong virtual sound mixing mode, the amplitude constraint parameter of the real audio signal and the amplitude constraint parameter of the virtual audio signal are both valid values, and the amplitude constraint parameter of the virtual audio signal is greater than the amplitude constraint parameter of the real audio signal;
in the equivalent sound mixing mode, the amplitude constraint parameter of the real audio signal and the amplitude constraint parameter of the virtual audio signal are both valid values, and the amplitude constraint parameter of the virtual audio signal is equal to the amplitude constraint parameter of the real audio signal;
in the real-closed sound mixing mode, the amplitude constraint parameter of the real audio signal is an invalid value, and the amplitude constraint parameter of the virtual audio signal is a valid value; and
in the virtual-closed sound mixing mode, the amplitude constraint parameter of the real audio signal is a valid value, and the amplitude constraint parameter of the virtual audio signal is an invalid value.

In an embodiment, when performing signal level monitoring on the current audio signal to obtain the level description value of the current audio signal, the processor 801 is specifically configured to:
perform framing processing on the current audio signal to obtain K audio frames of the current audio signal, where K is an integer greater than 1;
traverse the K audio frames, and determine a currently traversed i^{th} audio frame, where i∈[1, K];
perform signal level monitoring on the i^{th} audio frame to obtain a level description value of the i^{th} audio frame; or perform voice validity determination processing on the i^{th} audio frame, and perform signal level monitoring on the i^{th} audio frame in a case of determining that the i^{th} audio frame is a valid audio frame, to obtain a level description value of the i^{th} audio frame; and
continue traversal until the K audio frames are all traversed to obtain the level description value of the current audio signal, where the level description value of the current audio signal includes level description values of the audio frames obtained through monitoring.

In an embodiment, each audio frame includes a plurality of sampling points and amplitudes of the sampling points; and when performing signal level monitoring on the i^{th} audio frame to obtain the level description value of the i^{th} audio frame, the processor 801 is specifically configured to:
perform mean calculation on the amplitudes of the sampling points in the i^{th} audio frame to obtain a signal amplitude mean of the i^{th} audio frame; and
perform smoothing processing on the signal amplitude mean of the i^{th} audio frame to obtain the level description value of the i^{th} audio frame.

In an embodiment, when performing smoothing processing on the signal amplitude mean of the i^{th} audio frame to obtain the level description value of the i^{th} audio frame, the processor 801 is specifically configured to:
search the K audio frames for a reference audio frame of the i^{th} audio frame, where if voice validity determination processing is not performed on the i^{th} audio frame, the reference audio frame includes an (i−1)^{th} audio frame; or if voice validity determination processing is performed on the i^{th} audio frame, the reference audio frame includes a valid audio frame that is located before the i^{th} audio frame and closest to the i^{th} audio frame;
if the reference audio frame is not found, use the signal amplitude mean of the i^{th} audio frame as the level description value of the i^{th} audio frame; or
if the reference audio frame is found, perform smoothing processing on the signal amplitude mean of the i^{th} audio frame by using a level description value of the reference audio frame, to obtain the level description value of the i^{th} audio frame.

In an embodiment, the current audio signal is framed into K audio frames; the level description value of the current audio signal includes level description values of J audio frames on which signal level monitoring is performed in the K audio frames, where K is an integer greater than 1 and J≤K; the obtained amplitude constraint parameter includes a target amplitude and an amplitude gain threshold; and
when controlling, according to the obtained amplitude constraint parameter and the level description value of the current audio signal, the gain required by the amplitude of the current audio signal, to obtain the amplitude gain of the current audio signal, the processor 801 is specifically configured to:
traverse the J audio frames related to the level description value of the current audio signal to determine a currently traversed j^{th} audio frame, where j∈[1, J];
perform gain prediction by using the target amplitude in the obtained amplitude constraint parameter and a level description value of the j^{th} audio frame to obtain a predicted amplitude gain, where the predicted amplitude gain is a gain required for adjusting the level description value of the j^{th} audio frame to the target amplitude;
determine a smaller value of the amplitude gain threshold of the obtained amplitude constraint parameter and the predicted amplitude gain as a frame amplitude gain required for adjusting an amplitude of the j^{th} audio frame; and
continue traversal until the J audio frames are all traversed to obtain the amplitude gain of the current audio signal, where the amplitude gain of the current audio signal includes a frame amplitude gain corresponding to each audio frame in the J audio frames.

In an embodiment, the current audio signal is framed into K audio frames, and the amplitude gain of the current audio signal includes frame amplitude gains of J audio frames on which signal level monitoring is performed in the K audio frames, where K is an integer greater than 1 and J≤K; and
when performing gain processing on the amplitude of the current audio signal by using the amplitude gain of the current audio signal to adjust the volume of the current audio signal, to obtain the current audio signal after volume adjustment, the processor 801 is specifically configured to:
traverse the J audio frames related to the level description value of the current audio signal to determine a currently traversed j^{th} audio frame, where j∈[1, J];
divide the j^{th} audio frame into N audio sub-blocks, and determine an amplitude of each audio sub-block in the N audio sub-blocks, where N is an integer greater than 1;
perform gain processing on the amplitude of each audio sub-block in the N audio sub-blocks level by level according to the frame amplitude gain of the j^{th} audio frame to adjust a volume of each audio sub-block;
after obtaining each audio sub-block after volume adjustment, obtain a j^{th} audio frame after volume adjustment through splicing by using each audio sub-block after volume adjustment; and
continue traversal until the J audio frames are all traversed to obtain J audio frames after volume adjustment, and splice the J audio frames after volume adjustment to obtain the current audio signal after volume adjustment.

In an embodiment, the processor 801 is further configured to:
determine an arrangement position of the j^{th} audio frame in the J audio frames;
if the determined arrangement position is not a first position, trigger to perform the operation of performing gain processing on the amplitude of each audio sub-block in the N audio sub-blocks level by level according to the frame amplitude gain of the j^{th} audio frame to adjust a volume of each audio sub-block; or
if the determined arrangement position is a first position, perform gain processing on the amplitude of each audio sub-block in the N audio sub-blocks respectively by using the frame amplitude gain of the j^{th} audio frame to adjust the volume of each audio sub-block.

In an embodiment, when performing gain processing on the amplitude of each audio sub-block in the N audio sub-blocks level by level according to the frame amplitude gain of the j^{th} audio frame, the processor 801 is specifically configured to:
determine a block amplitude gain of each audio sub-block according to the frame amplitude gain of the j^{th} audio frame and an arrangement position of each audio sub-block in the N audio sub-blocks in the N audio sub-blocks, where block amplitude gains of different audio sub-blocks change level by level along with increases of arrangement positions of the corresponding audio sub-blocks in the N audio sub-blocks; and
perform gain processing on an amplitude of a corresponding audio sub-block by using the block amplitude gain of each audio sub-block.

In an embodiment, the arrangement position of the j^{th} audio frame in the J audio frames is not a first position; and
when determining the block amplitude gain of each audio sub-block according to the frame amplitude gain of the j^{th} audio frame and the arrangement position of each audio sub-block in the N audio sub-blocks in the N audio sub-blocks, the processor 801 is specifically configured to:
determine a frame amplitude gain of a (j−1)^{th} audio frame in the J audio frames, and use a difference between the frame amplitude gain of the j^{th} audio frame and the frame amplitude gain of the (j−1)^{th} audio frame as a frame amplitude gain difference of the j^{th} audio frame relative to the (j−1)^{th} audio frame;
determine, for an n^{th} audio sub-block in the N audio sub-blocks, a required block amplitude gain change value of the n^{th} audio sub-block relative to the (j−1)^{th} audio frame according to an arrangement position of the n^{th} audio sub-block in the N audio sub-blocks and the frame amplitude gain difference, where n∈[1, N]; and
obtain a block amplitude gain of the n^{th} audio sub-block according to the block amplitude gain change value and the frame amplitude gain of the (j−1)^{th} audio frame.

In an embodiment, before performing sound mixing processing on the real the sound-mixed signal, the processor 801 is further configured to:
determine a scene type of the augmented reality scene, and perform sound effect processing on the real audio signal and the virtual audio signal in the augmented reality scene respectively according to a requirement of the scene type for a sound effect; or
obtain the environment type of the real environment on which the augmented reality scene is based, and perform sound effect processing on the real audio signal and the virtual audio signal in the augmented reality scene respectively according to a requirement of the environment type of the real environment for a sound effect, where
the sound effect processing includes at least one of the following: reverberation processing and balancing processing.

In an embodiment, each sound mixing mode in the plurality of sound mixing modes has a mode identifier, each mode identifier corresponds to one balancing parameter group required for performing balancing processing, and the balancing parameter group corresponding to any mode identifier includes: a first volume balancing parameter of the virtual audio signal in a corresponding sound mixing mode and a second volume balancing parameter of the real audio signal in the corresponding sound mixing mode; and
before performing sound mixing processing on the real audio signal and the virtual audio signal according to the target sound mixing mode to obtain the sound-mixed signal, the processor 801 is further configured to:
obtain a balancing parameter group corresponding to the mode identifier of the target sound mixing mode; and
perform balancing processing on the virtual audio signal by using the first volume balancing parameter in the obtained balancing parameter group, and perform balancing processing on the real audio signal by using the second volume balancing parameter in the obtained balancing parameter group.

In this embodiment of this application, a real audio signal and a virtual audio signal in an augmented reality scene may be obtained. A plurality of sound mixing modes configured for the augmented reality scene are determined, and one sound mixing mode is selected from the plurality of sound mixing modes as a target sound mixing mode, where different sound mixing modes may be configured for realizing different sound mixing effects between the real audio signal and the virtual audio signal, thereby bringing different auditory experiences. By determining the plurality of sound mixing modes for the augmented reality scene, diversified selections can be provided for setting of the target sound mixing mode, and the target sound mixing mode can be flexibly set, so that various scenes in which the real audio signal and the virtual audio signal need to be mixed can be adapted to, and some personalized sound mixing requirements of the user can also be met. Sound mixing processing is performed on the real audio signal and the virtual audio signal according to the target sound mixing mode to obtain a sound-mixed signal, and the sound-mixed signal is outputted. Since the target sound mixing mode can realize a corresponding sound mixing effect between the real audio signal and the virtual audio signal, by controlling sound mixing processing on the real audio signal and the virtual audio signal in the target sound mixing mode, integration of sounds in the real world and sounds in the virtual world on which the augmented reality scene is based may be realized in an auditory dimension, so that sound integration in the augmented reality scene is increased in the auditory aspect, an integration capability in the augmented reality scene is enriched, and the obtained sound-mixed signal also has the sound mixing effect corresponding to the target sound mixing mode. The sound-mixed signal is finally outputted, so that the user can feel a sound integration effect in the augmented reality scene more intuitively, thereby improving an immersed sense of the user in the augmented reality scene.

In addition, an embodiment of this application further provides a computer-readable storage medium, having a computer program stored therein, and the computer program includes program instructions. When the program instructions are executed by a processor, the methods in the embodiments corresponding to FIG. 2 and FIG. 4 can be performed. Therefore, details are not described herein again. For technical details that are not disclosed in the embodiments of the computer-readable storage medium included in this application, reference may be made to the description of the method embodiments of this application. In an example, the program instructions may be deployed on one computer device for execution, or on a plurality of computer devices located at the same location for execution, or on a plurality of computer devices distributed at a plurality of locations and interconnected by a communication network for execution.

According to an aspect of this application, a computer program product is provided, including a computer program, the computer program being stored in a computer-readable storage medium. A processor of a computer device reads the computer program from the computer-readable storage medium and executes the computer program, so that the computer device may implement the methods in the embodiments corresponding to FIG. 2 and FIG. 4 above. Therefore, details are not described herein again.

A person of ordinary skill in the art may understand that all or some of the procedures of the methods of the foregoing embodiments may be implemented by a computer program instructing relevant hardware. The program may be stored in a computer-readable storage medium. When the program is executed, the procedures of the foregoing method embodiments may be implemented. The storage medium may be a magnetic disk, an optical disc, a read-only memory (ROM), a random access memory (RAM), or the like.

The content disclosed above is merely preferred embodiments of this application, but is not intended to limit the scope of the claims of this application. A person of ordinary skill in the art can understand all or some of the procedures for implementing the foregoing embodiments, and any equivalent variation made according to the claims of this application shall still fall within the scope of this application.

What is claimed is:

1. An audio processing method performed by a computer device, comprising:
obtaining a real audio signal from a real environment and a virtual audio signal from a virtual environment in an augmented reality scene;
selecting one sound mixing mode from a plurality of sound mixing modes configured for the augmented reality scene as a target sound mixing mode;
performing sound mixing processing on the real audio signal and the virtual audio signal according to the target sound mixing mode to obtain a sound-mixed signal; and
outputting the sound-mixed signal via a speaker of the computer device.

2. The method according to claim 1, wherein the selecting one sound mixing mode from the plurality of sound mixing modes configured for the augmented reality scene as the target sound mixing mode comprises:
obtaining a mode configuration operation from a user of the computer device, wherein the mode configuration operation comprises: a select operation for a plurality of mode identifiers displayed in an augmented reality application, wherein one mode identifier corresponds to one sound mixing mode; and
selecting one sound mixing mode from the plurality of sound mixing modes as the target sound mixing mode according to the mode configuration operation.

3. The method according to claim 1, wherein the selecting one sound mixing mode from the plurality of sound mixing modes configured for the augmented reality scene as the target sound mixing mode comprises:
determining an environment type of the real environment according to geographical position information of the real environment; and
selecting one sound mixing mode from the plurality of sound mixing modes as the target sound mixing mode according to the determined environment type for sound integration.

4. The method according to claim 1, wherein the performing sound mixing processing on the real audio signal and the virtual audio signal according to the target sound mixing mode to obtain a sound-mixed signal comprises:
performing volume adjustment on the real audio signal and the virtual audio signal respectively according to the target sound mixing mode, to obtain an adjusted real audio signal and an adjusted virtual audio signal; and
mixing the adjusted real audio signal and the adjusted virtual audio signal to obtain the sound-mixed signal.

5. The method according to claim 4, wherein the performing volume adjustment on the real audio signal and the virtual audio signal respectively according to the target sound mixing mode comprises:
traversing the real audio signal and the virtual audio signal, using a currently traversed audio signal as a current audio signal, and obtaining an amplitude constraint parameter of the current audio signal in the target sound mixing mode;
performing signal level monitoring on the current audio signal to obtain a level description value of the current audio signal;
controlling, according to the obtained amplitude constraint parameter and the level description value of the current audio signal, a gain required by the amplitude of the current audio signal, to obtain an amplitude gain of the current audio signal; and
performing gain processing on the amplitude of the current audio signal by using the amplitude gain of the current audio signal to adjust a volume of the current audio signal, to obtain a current audio signal after volume adjustment.

6. The method according to claim 1, wherein before the performing sound mixing processing on the real audio signal and the virtual audio signal according to the target sound mixing mode to obtain a sound-mixed signal, the method further comprises:
determining a scene type of the augmented reality scene;
obtaining the environment type of the real environment on which the augmented reality scene is based;
performing sound effect processing on the real audio signal and the virtual audio signal in the augmented reality scene respectively according to at least one of the scene type and the environment type of the real environment for a sound effect, wherein the sound effect processing comprises at least one of the following: reverberation processing and balancing processing.

7. The method according to claim 1, wherein each sound mixing mode in the plurality of sound mixing modes has a mode identifier corresponding to one balancing parameter group required for performing balancing processing, and the balancing parameter group comprises:
a first volume balancing parameter of the virtual audio signal in a corresponding sound mixing mode and a second volume balancing parameter of the real audio signal in the corresponding sound mixing mode.

8. The method according to claim 7, wherein before the performing sound mixing processing on the real audio signal and the virtual audio signal according to the target sound mixing mode to obtain the sound-mixed signal, the method further comprises:
obtaining a balancing parameter group corresponding to the mode identifier of the target sound mixing mode; and
performing balancing processing on the virtual audio signal by using the first volume balancing parameter in the obtained balancing parameter group, and performing balancing processing on the real audio signal by using the second volume balancing parameter in the obtained balancing parameter group.

9. A computer device, comprising:
a processor, configured to execute a computer program; and
a computer-readable storage medium, having a computer program stored therein, wherein the computer program, when executed by the processor, causes the computer device to perform an audio processing method including:
obtaining a real audio signal from a real environment and a virtual audio signal from a virtual environment in an augmented reality scene;
selecting one sound mixing mode from a plurality of sound mixing modes configured for the augmented reality scene as a target sound mixing mode;
performing sound mixing processing on the real audio signal and the virtual audio signal according to the target sound mixing mode to obtain a sound-mixed signal; and
outputting the sound-mixed signal via a speaker of the computer device.

10. The computer device according to claim 9, wherein the selecting one sound mixing mode from the plurality of sound mixing modes configured for the augmented reality scene as the target sound mixing mode comprises:
obtaining a mode configuration operation from a user of the computer device, wherein the mode configuration operation comprises: a select operation for a plurality of mode identifiers displayed in an augmented reality application, wherein one mode identifier corresponds to one sound mixing mode; and
selecting one sound mixing mode from the plurality of sound mixing modes as the target sound mixing mode according to the mode configuration operation.

11. The computer device according to claim 9, wherein the selecting one sound mixing mode from the plurality of sound mixing modes configured for the augmented reality scene as the target sound mixing mode comprises:
determining an environment type of the real environment according to geographical position information of the real environment; and
selecting one sound mixing mode from the plurality of sound mixing modes as the target sound mixing mode according to the determined environment type for sound integration.

12. The computer device according to claim 9, wherein the performing sound mixing processing on the real audio signal and the virtual audio signal according to the target sound mixing mode to obtain a sound-mixed signal comprises:
performing volume adjustment on the real audio signal and the virtual audio signal respectively according to the target sound mixing mode, to obtain an adjusted real audio signal and an adjusted virtual audio signal; and
mixing the adjusted real audio signal and the adjusted virtual audio signal to obtain the sound-mixed signal.

13. The computer device according to claim 12, wherein the performing volume adjustment on the real audio signal and the virtual audio signal respectively according to the target sound mixing mode comprises:
traversing the real audio signal and the virtual audio signal, using a currently traversed audio signal as a current audio signal, and obtaining an amplitude constraint parameter of the current audio signal in the target sound mixing mode;
performing signal level monitoring on the current audio signal to obtain a level description value of the current audio signal;
controlling, according to the obtained amplitude constraint parameter and the level description value of the current audio signal, a gain required by the amplitude of the current audio signal, to obtain an amplitude gain of the current audio signal; and
performing gain processing on the amplitude of the current audio signal by using the amplitude gain of the current audio signal to adjust a volume of the current audio signal, to obtain a current audio signal after volume adjustment.

14. The computer device according to claim 9, wherein before the performing sound mixing processing on the real audio signal and the virtual audio signal according to the target sound mixing mode to obtain a sound-mixed signal, the method further comprises:
determining a scene type of the augmented reality scene;
obtaining the environment type of the real environment on which the augmented reality scene is based;
performing sound effect processing on the real audio signal and the virtual audio signal in the augmented reality scene respectively according to at least one of the scene type and the environment type of the real environment for a sound effect, wherein
the sound effect processing comprises at least one of the following: reverberation processing and balancing processing.

15. The computer device according to claim 9, wherein each sound mixing mode in the plurality of sound mixing modes has a mode identifier corresponding to one balancing parameter group required for performing balancing processing, and the balancing parameter group comprises: a first volume balancing parameter of the virtual audio signal in a corresponding sound mixing mode and a second volume balancing parameter of the real audio signal in the corresponding sound mixing mode.

16. The computer device according to claim 15, wherein before the performing sound mixing processing on the real audio signal and the virtual audio signal according to the target sound mixing mode to obtain the sound-mixed signal, the method further comprises:
obtaining a balancing parameter group corresponding to the mode identifier of the target sound mixing mode; and
performing balancing processing on the virtual audio signal by using the first volume balancing parameter in the obtained balancing parameter group, and performing balancing processing on the real audio signal by using the second volume balancing parameter in the obtained balancing parameter group.

17. A non-transitory computer-readable storage medium, having a computer program stored therein, wherein when the computer program, when executed by a processor of a computer device, causes the computer device to perform an audio processing method including:
obtaining a real audio signal from a real environment and a virtual audio signal from a virtual environment in an augmented reality scene;
selecting one sound mixing mode from a plurality of sound mixing modes configured for the augmented reality scene as a target sound mixing mode;
performing sound mixing processing on the real audio signal and the virtual audio signal according to the target sound mixing mode to obtain a sound-mixed signal; and
outputting the sound-mixed signal via a speaker of the computer device.

18. The non-transitory computer-readable storage medium according to claim 17, wherein the selecting one sound mixing mode from the plurality of sound mixing modes configured for the augmented reality scene as the target sound mixing mode comprises:
obtaining a mode configuration operation from a user of the computer device, wherein the mode configuration operation comprises: a select operation for a plurality of mode identifiers displayed in an augmented reality application, wherein one mode identifier corresponds to one sound mixing mode; and
selecting one sound mixing mode from the plurality of sound mixing modes as the target sound mixing mode according to the mode configuration operation.

19. The non-transitory computer-readable storage medium according to claim 17, wherein the performing sound mixing processing on the real audio signal and the virtual audio signal according to the target sound mixing mode to obtain a sound-mixed signal comprises:
performing volume adjustment on the real audio signal and the virtual audio signal respectively according to the target sound mixing mode, to obtain an adjusted real audio signal and an adjusted virtual audio signal; and
mixing the adjusted real audio signal and the adjusted virtual audio signal to obtain the sound-mixed signal.

20. The non-transitory computer-readable storage medium according to claim 17, wherein before the performing sound mixing processing on the real audio signal and the virtual audio signal according to the target sound mixing mode to obtain a sound-mixed signal, the method further comprises:
determining a scene type of the augmented reality scene;
obtaining the environment type of the real environment on which the augmented reality scene is based;
performing sound effect processing on the real audio signal and the virtual audio signal in the augmented reality scene respectively according to at least one of the scene type and the environment type of the real environment for a sound effect, wherein
the sound effect processing comprises at least one of the following: reverberation processing and balancing processing.
